(19) United States
(12) Patent Application Publication
(10) Pub. No.: US 2026/0259793 A1
(43) Pub. Date: Sep. 3, 2026

(54) FAULT RESILIENT TRANSACTION HANDLING DEVICE

(71) Applicant: Mellanox Technologies, Ltd., Yokneam Illit (IL)

(72) Inventors: Ran Avraham Koren, Beijing (CN); Eliav Bar-Ilan, Or Akiva (IL); Omri Kahalon, Yehud (IL); Liran Liss, Atzmon (IL); Daniel Marcovitch, Yokneam Illit (IL); Parav Kanaiyalal Pandit, Atlanta, GA (US); Aviad Shaul Yehezkel, Yokneam Illit (IL)

(21) Appl. No.: 18/994,526

(22) PCT Filed: Jul. 14, 2022
(86) PCT No.: PCT/CN2022/105691

§ 371 Date: Jan. 14, 2025

(51) Int. Cl. G06F 11/07

(52) U.S. Cl. CPC G06F 11/0793; G06F 11/0745

(57) ABSTRACT

Embodiments of the present disclosure are directed to apparatuses, systems, and techniques of a fault resilient transaction handling device for a virtualized system. A request to initiate a transaction involving a direct memory access (DMA) operation to access data associated with one or more guests is received at a device connected to a computing system that hosts the one or more guests. A page fault associated with execution of the DMA operation of the transaction is detected. A transaction fault handling protocol that is to be initiated to address the detected page fault is selected from a set of transaction fault handling protocols. The selected transaction fault handling protocol is caused to be performed to address the detected page fault.

### CLAIM OF PRIORTY

This application is a National Stage of International Application No. PCT/CN2022/105691, filed Jul. 14, 2022, which is incorporated by reference herein.

### TECHNICAL FIELD

At least one embodiment pertains to processing resources used to perform and facilitate operations associated with a fault resilient transaction handling device.

### BACKGROUND

A computing system (e.g., a host system) can abstract and/or emulate one or more virtualized systems (e.g., guest system(s)) as standalone computing systems (e.g., from a user perspective). A virtualization manager of the host system can expose a hardware device (e.g., a networking device, a storage device, a graphics processing device, etc.) as one or more virtual devices to the guest (e.g., as part of the virtualized system) and can enable the guest to communicate directly with the virtual device. Direct memory access (DMA) refers to a feature of computing systems that allows hardware to access memory without involving a processing unit (e.g., a central processing unit (CPU), etc.). A computing system having DMA-capable devices often uses an input/output memory management unit (IOMMU) to manage address translations between device address space (e.g., that is relevant to the device) and physical address space (e.g., that is relevant to the host system). In a virtualized system, the guest operates in a guest address space and is unaware of the physical memory address for data that the guest is accessing. If the guest instructs a virtual device to perform DMA using an address of the guest address space, the hardware device underlying the virtual device would be unaware of the mapping between the guest address space and the physical address space and accordingly, the DMA operation could be performed at an incorrect physical address.

In some instances, a host system can expose a larger amount of physical memory to each guest than is actually present in the physical address space (referred to as memory overcommitment). As a result, data associated with a guest can be removed from the physical address space to a second data storage (referred to as memory swapping) when the data is not accessed for a period of time. If a physical device executes a DMA operation to access memory that has been swapped out of the physical address space, an error (e.g., a page fault) will occur.

### BRIEF DESCRIPTION OF DRAWINGS

Various embodiments in accordance with the present disclosure will be described with reference to the drawings, in which:

FIG. 1A is a block diagram of an example system architecture, according to at least one embodiment;

FIG. 1B is a block diagram of another example system architecture, according to at least one embodiment;

FIG. 2 is a block diagram of an example device and an example computing system, according to at least one embodiment;

FIG. 3 illustrates a block diagram of one or more engines associated with a fault resilient transaction handling device, according to at least one embodiment;

FIG. 4 illustrates an example fault handling data structure, according to at least one embodiment;

FIG. 5 illustrates a flow diagram of an example method for handling page faults at a fault resilient transaction handling device, according to at least one embodiment;

FIG. 6A illustrates a flow diagram of an example method for priority-based paging requests, according to at least one embodiment;

FIG. 6B illustrates a flow diagram of another example method for priority-based paging requests, according to at least one embodiment;

FIG. 7 illustrates a flow diagram of yet another example method for priority-based paging requests, according to at least one embodiment;

FIGS. 8A-8B illustrate an example of completion handling for one or more faulted transactions at a device; according to at least one embodiment;

FIGS. 9A-9B illustrate another example of completion handling for one or more faulted transactions at a device; according to at least one embodiment;

FIG. 10 illustrates an example completion recovery engine of a fault resilient transaction handling device, according to at least one embodiment;

FIG. 11 illustrates a flow diagram of an example method for completion synchronization, according to at least one embodiment;

FIG. 12 illustrates a block diagram illustrating an exemplary computer device, in accordance with implementations of the present disclosure.

### DETAILED DESCRIPTION

Modern computing systems (e.g., computing systems for data centers, etc.) can provide access to resources in a virtualized environment (e.g., a virtual machine, a container, etc.). For instance, a virtualization manager of a computing system (referred to herein as a “host system” or simply a “host”) can abstract and/or emulate one or more virtualized systems (referred to herein as a “guest system” or simply a “guest”) as standalone computing systems (e.g. from a user perspective). A virtualization manager can be part of a host operating system, a hypervisor, a virtual machine monitor, or the like, and a guest may be a virtual machine, a container, or the like. The virtualization manager can expose physical resources of the host as virtual resources to a respective guest. For example, a virtualization manager can partition one or more regions of physical memory of the host (e.g., random access memory (RAM), storage memory, etc.) and can expose a collection of such partitioned regions of memory to a guest as virtual memory (referred to herein as “guest memory”). Memory in a contiguous physical memory address space or a non-contiguous physical memory address space can be exposed to a guest as guest memory in a contiguous guest memory address space.

As a guest may not consume all of the guest memory allocated by the virtualization manager at any one point in time, some virtualization managers can expose a larger amount of memory to each guest than is actually present in the physical memory space. Such practice (referred to as memory overcommitment) can expand the amount of physical memory space that is available to a guest without significantly impacting access to the guest memory for any single guest. If a guest attempts to access data that is not, at the time, residing at a region of physical memory that is allocated as guest memory (e.g., and is instead residing at a secondary storage of the host), the virtualization manager can swap out other data from the allocated region of memory in accordance with a memory eviction protocol implemented at the computing system and can copy the requested data (e.g., from the secondary storage) to replace the swapped out data. Such practice is referred to herein as memory swapping.

In some computing systems, the virtualization manager can expose a physical device (e.g., a networking device, a storage device, a graphics processing device, etc.) as one or more virtualized devices to the guest. For example, the virtualization manager can partition resources of a respective physical device (referred to herein simply as a “device”) to be accessible by one or more guests and can expose and/or emulate a collection of such partitioned resources to a virtualized system as a virtual device. The guest can accordingly communicate directly with the virtual device exposed by the virtualization manager (e.g., via a virtual connection such as a virtual bus).

Direct memory access (DMA) refers to a feature of computing systems that allows hardware to access memory without involving a processing unit (e.g., a central processing unit (CPU), etc.). A computing system can maintain an input/output memory management unit (IOMMU), which includes a mapping between a respective DMA memory address (e.g., that is relevant to a device) and a physical address indicating a region of physical memory that stores data. In non-virtualized systems, the mapping can be provided and/or maintained by a driver associated with the device (e.g., that is running via a processing unit of the computing system). The device can access data residing in physical memory of the computing system by transmitting a request indicating a respective DMA memory address for data to be accessed. The respective DMA memory address is translated to a physical memory address using the IOMMU and the data residing at the physical memory address can be retrieved at the region of memory associated with the physical memory address (e.g., without involving decoding and analysis of the request by a processing unit of the computing system). To ensure that data associated with a DMA memory address is available in the physical memory, one or more components of the computing system (e.g., an operating system (OS), etc.) can update metadata associated with the data to indicate that the data is not to be removed from or replaced at a particular region of the physical memory (referred to herein as “data pinning,” “memory pinning,” or simply as “pinning”) and can update a mapping for the respective DMA memory address at the IOMMU to indicate the physical address for the particular region including the data. The pinned data can reside at the particular region of the physical memory until the operating system detects that the data is to be “unpinned” (e.g., metadata associated with the data is updated to indicate that the data can be removed from or replaced at the particular region).

In a virtualized environment, the IOMMU is managed by the virtualization manager. The virtualization manager may expose portions of the IOMMU to the guests as a virtual IOMMU (vIOMMU) (e.g., portions of the IOMMU that include page tables that provide a mapping between various levels of guest address space, etc.). However, portions of the IOMMU that are involved with translating DMA memory addresses to a physical memory address are not exposed to the guest and therefore cannot be directly accessed by a guest or the device. Accordingly, the driver for the hardware device is unable to access the IOMMU to map and/or pin data in the guest address space. The device driver can transmit a request to the virtualization manager to map and/or pin memory in the guest address space. However, the device driver is unaware of the host address space allocated to the guest and therefore is unable to designate the regions of the host address space to correspond to guest memory. Accordingly, the device driver is unable to facilitate mapping and/or pinning in the host address space and/or at the IOMMU.

In order to address the above described issues, some virtualization managers provide an emulation service in which a virtualization manager presents to a guest a software interface that typically appears to be identical (e.g., from the perspective of the guest) to an interface between the computing system and a physical device. According to such techniques, the guest may not have direct access to virtual device and may instead access the emulated device via the software interface presented by the virtualization manager. The guest can transmit a DMA memory address for a particular region of guest address space to the virtualization manager and the virtualization manager can map the DMA memory address to a corresponding guest address at the IOMMU and/or can pin memory associated with the guest address in the host address space. As a host system can host multiple guests, mapping and/or pinning memory to enable DMA access between each guest and the emulated device can take a significant amount of time and accordingly consume a substantial amount of computing resources. As a result, fewer resources are available for other processes at the computing system, which can decrease an overall efficiency and increase an overall latency for the system.

According to other techniques, a virtualization manager can map an entire portion of host memory allocated to a guest to DMA memory space and can pin the guest memory to the IOMMU prior to or during an initialization period for the guest at the computing system (referred to as static mapping and static pinning). In such implementations, the guest can provide a DMA memory address to the device and the device can execute a DMA operation using the provided DMA memory address. However, mapping the entire allocated potion of host memory and/or pinning the entire guest memory can take a significant amount of time, which can consume a substantial amount of computing resources. In addition, as the entire guest memory is pinned in order to enable DMA access, the virtualization manager may no longer implement overcommitment techniques to optimize memory access for each respective guest hosted at the computing system. Further, pinning the entire guest memory can block various optimization techniques that can be otherwise implemented by an OS running on the host (e.g., kernel memory sharing, etc.).

According to yet other techniques, a virtualization manager can intercept requests from the guest to map and/or pin portions of guest memory. The virtualization manager can map DMA memory addresses to corresponding guest addresses and/or can pin the host memory as such requests are intercepted (referred to as dynamic mapping and dynamic pinning). The guest can provide a DMA memory address to the device and the device can execute a DMA operation using the provided DMA address, as described above. However, switching between executing operations of the guest and executing operations of the virtualization manager at the computing system can be computationally expensive and can negatively impact the performance of applications running on the guest. In addition, guests may be unaware and unable to cooperate with DMA mapping mechanisms that enable the guest to facilitate DMA mapping and/or pinning. Accordingly, such techniques cannot be applied to each type of guest running on a host system. Finally, a guest that is able to cooperate with DMA mapping mechanisms that enable the guest to facilitate DMA mapping and/or pinning can, in some instances, map and/or pin the entire guest memory address space of the physical memory. In such instances, the virtualization manager may not be able to implement memory overcommit techniques to optimize memory access for each respective guest hosted at the computing system without invoking computationally complex protocols, which can decrease an overall efficiency and increase an overall latency of the computing system. Further, a malicious guest hosted at the computing system can abuse the interface between the virtualization manager and the guests (e.g., by consuming a larger amount of host memory than is configured for allocation to the malicious guest), which can impact performance of other guests and/or the computing system.

In some systems, a device that is abstracted or emulated for a guest by a virtualization manager can issue a mapping request to the virtualization manager (e.g., in response to receiving a DMA memory address from the guest). The virtualization manager can map the guest memory, as described above. In such implementations, the device is aware of the state of each page of the guest memory (e.g., whether a guest page is mapped in guest memory) and can issue the mapping request in response to determining that a page referenced by the guest does not currently reside at the physical memory (referred to herein as a page fault). While the device controller waits for a confirmation from the virtualization manager that the guest memory page is available in the physical memory and/or mapped at the IOMMU, the device controller can implement a page fault handling protocol at the device. For example, each DMA operation can be at least one of multiple operations of a transaction initiated at the device. The page fault handling protocol can involve the device controller stalling each operation of the transaction at the device until confirmation is received that the guest memory page is available in the physical memory and/or the guest memory page is mapped at the IOMMU. It can take a significant amount of time (e.g., one second or more) for the device to receive confirmation that the guest memory page is available and/or is pinned at the IOMMU, which can substantial delay completion of the transaction and/or impact subsequent transactions. Such a delay can greatly increase a latency and decrease an efficiency associated with the device and the computing system. In another example, a page fault handling protocol for a device, such as a networking device, can involve the device receiving a request to initiate a DMA operation to access a guest memory page, dropping the request and transmitting to the requestor a notification indicating that the device is currently unable to service the request and that the requestor should retransmit the request at a later time.

In conventional systems, the same page fault handling protocol can be implemented by the device for each detected page fault. While delaying completion of the transaction and/or dropping requests and instructing the requestor to retransmit the request at a later time may be appropriate in some instances, such approach may not be appropriate in every situation. For instance, stalling transactions at a networking device can significantly interrupt network traffic (e.g., for milliseconds or longer), which can increase a latency and decrease an efficiency and throughput for the entire system. Other types of devices (e.g., data processing unit (DPU) emulated devices, etc.) may be associated with other types of constraints, which can make stalling transactions a time consuming and costly approach to addressing a guest page fault for DMA operations.

Further, conventional techniques generally do not provide a mechanism that enables a device to pin guest memory pages at the IOMMU to ensure that such guest memory pages are available in guest memory for future DMA operations and prevent page faults from occurring. If guest memory pages that are frequently accessed by a particular virtual device are not pinned at the IOMMU, such memory pages can be evicted from the guest memory and page faults can occur when the virtual device attempts to access such pages, as described above. As each page fault can cause a delay of transactions at the device, an overall latency for the system can be further increased, and an overall efficiency and throughput for the system can be further decreased.

In addition, systems can access metadata (e.g., for work requests, for completion requests, etc.) using DMA techniques, as described above. In some instances, if page faults occur (e.g., when the device attempts to access memory pages including data and memory pages including metadata), such systems can execute operations to handle a page fault for the data memory pages and/or a memory pages including the metadata. In an illustrative example, data of an inbound network packet may be successfully written to a memory page (e.g., by execution of a DMA operation), but reporting the completion of the successfully written data may incur a page fault. In such instances, the device may implement an additional fault handling protocol to handle the page fault, which can delay transactions at the device, thereby increasing an overall latency for the system and decreasing an overall efficiency and throughput for the system.

Embodiments of the present disclosure address the above and other deficiencies by providing techniques for a transaction aware device for a virtualized system. The transaction aware device can include a device that can be abstracted and/or emulated, by a virtualization manager, as one or more virtual devices for guests provided by a host system. In some embodiments, the transaction aware device can include a networking device, (e.g., a NIC device), a storage device, a data processing unit (DPU) device, and so forth. In some embodiments, the transaction aware device can include an emulation capable device that can expose multiple emulated devices, each having a distinct interface type, to a host system.

The fault resilient transaction handling device (referred to herein as “device”) can be configured to implement one or more of a set of transaction fault handling protocols in response to detecting a page fault during execution of a DMA operation of a transaction. A transaction refers to a series of one or more operations that are executed to perform a particular task associated with a device. A transaction can include one or more DMA operations and/or one or more non-DMA operations. The device can execute operations for one or more engines (e.g., a page handling engine, a transaction handling engine, an asynchronous request engine, etc.) for identifying and implementing the fault handling technique(s), as described herein.

In some embodiments, the device can receive a request to initiate a transaction involving a DMA operation to access data associated with one or more guests of a host system. In response to detecting a page fault associated with execution of the transaction, the device can select a transaction fault handling protocol to be initiated to address the detected page fault. The transaction fault handling protocol can be selected based on one or more match criteria for the device, which can include one or more characteristics of the guest(s) associated with the transaction, one or more properties associated with the transaction, and/or one or more properties associated with a prior transaction initiated at the device. In an illustrative example, the device processor(s) can have access to a transaction fault handling data structure that includes multiple transaction fault handling protocols that are each associated with one or more match criteria. The device processor(s) can identify an entry of the transaction fault handling data structure that corresponds to the characteristics of the guests(s), properties of the transaction, and/or properties of one or more prior transaction(s) and can determine the transaction fault handling protocol based on the identified entry, in some embodiments. The device processor(s) can cause the selected transaction fault handling protocol to be performed to address the detected page fault. In some embodiments, a transaction fault handling protocol can involve rescheduling at least one operation (e.g., a DMA operation or a non-DMA operation) of the transaction, terminating the DMA operation of the transaction, and/or updating a memory address associated with the DMA operation to correspond to another memory address. Further details regarding selecting and performing a respective transaction fault handling protocol are described herein.

In additional or alternative embodiments, the fault resilient transaction handling device can be configured to transmit requests to a virtualization manager associated with the guest(s) to make one or more memory pages associated with guest data available at a particular region of host memory and/or pin the one or more memory pages to the particular region of the host memory. For example, when a request to initiate a transaction is received at the device, the transaction can be added to a transaction queue. The device can evaluate one or more transactions added to the transaction queue and can determine one or more memory pages that are to be accessed during execution of operations of the one or more transactions. The device can determine whether data of the memory page(s) currently resides at the host memory and, if not, can transmit one or more requests to the virtualization manager to make the data of the memory pages available at the host memory, in some embodiments. In additional or alternative embodiments, device processor(s) can determine whether data of the determined one or more memory pages should remain in the host memory (e.g., at least until execution of the operations of the one or more transactions is completed). If the data should remain in the host memory, the device can transmit one or more requests to the virtualization manager to pin the memory pages at the host memory. Once device processor(s) have determined that execution of the operations of the one or more transactions is completed, device processor(s) can transmit one or more requests to the virtualization manager to unpin (e.g., release) the memory pages at the host memory.

Aspects and embodiments of the present disclosure provide techniques that enable a device to handle page faults caused by a DMA operation of a transaction according to a transaction fault handling protocol that is selected based on characteristics of a guest, properties of the transaction, and/or properties of prior transactions at the device. For example, if a networking device receives a request to write data to a particular region of guest memory using a DMA operation and a page fault is detected, the networking device can select a transaction fault handling protocol (e.g., writing the data to another region of the guest memory, etc.) that will resolve the detected page fault without stalling the transaction and interrupting network traffic. Accordingly, a completion of transactions (e.g., to access data and/or metadata for the request) at the device will not be unnecessarily delayed, which can increase an overall efficiency and throughput of the system and decrease an overall latency of the system. In addition, embodiments of the present disclosure provide techniques that enable the device to address page faults before they are encountered, which can significantly reduce a number of faulted transactions at the device. As the number of faulted transactions decreases, an overall throughput of the system increases. Further, as the number of faulted transactions decreases, fewer computing resources are consumed to handle such faulted transactions, which increases an overall efficiency and decreases an overall latency of the system. Finally, by enabling the device to request memory pages that are made available at host memory, the device can implement a page handling technique that improves performance at the device, rather than relying on page handling techniques (e.g., generic memory management algorithms) that may be implemented at a host computing system.

It should be noted that although some embodiments of the present disclosure refer to DMA operations, embodiments of the present disclosure can also be applied for remote DMA (RDMA) operations. Further details and examples relating to RDMA operations are described herein. It should also be noted that although some embodiments of the present disclosure refer to a computing system that hosts one or more guests, embodiments of the present disclosure can be applied to any type of computing system (e.g., computing systems that do not host guests, etc.). In addition, embodiments of the present disclosure that refer to guest data can also be applied to host data or any other type of data at a computing system.

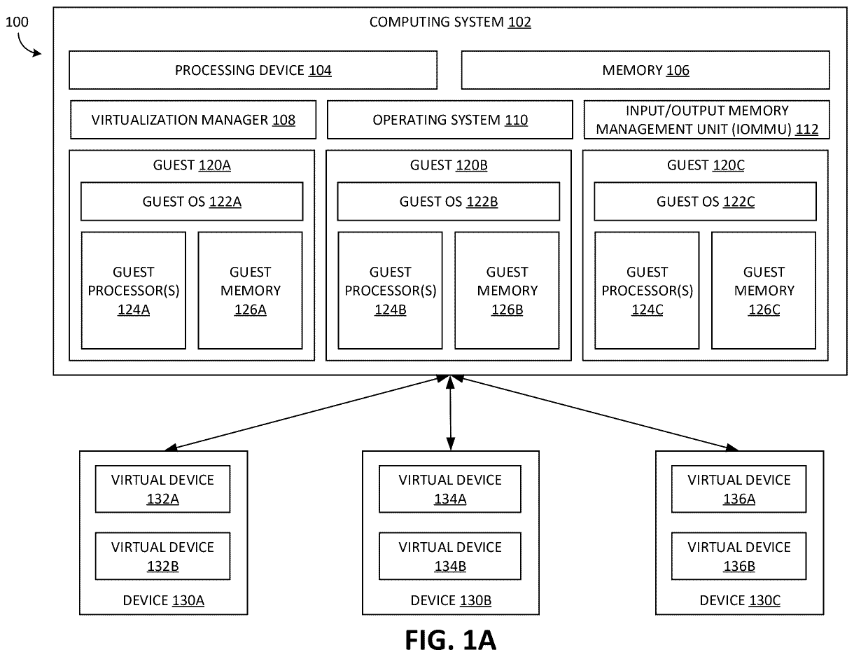

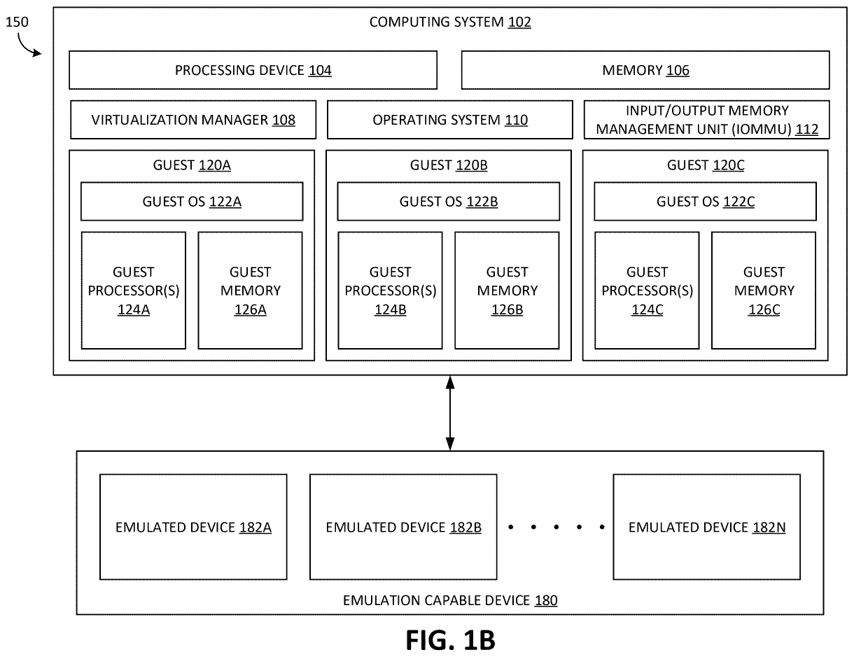

FIG. 1A is a high-level block diagram of an example system architecture 100, according to at least one embodiment. One skilled in the art will appreciate that other architectures for system architecture 100 are possible, and that the implementation of a system architecture utilizing embodiments and examples of the disclosure are not necessarily limited to the specific architecture depicted by FIG. 1A

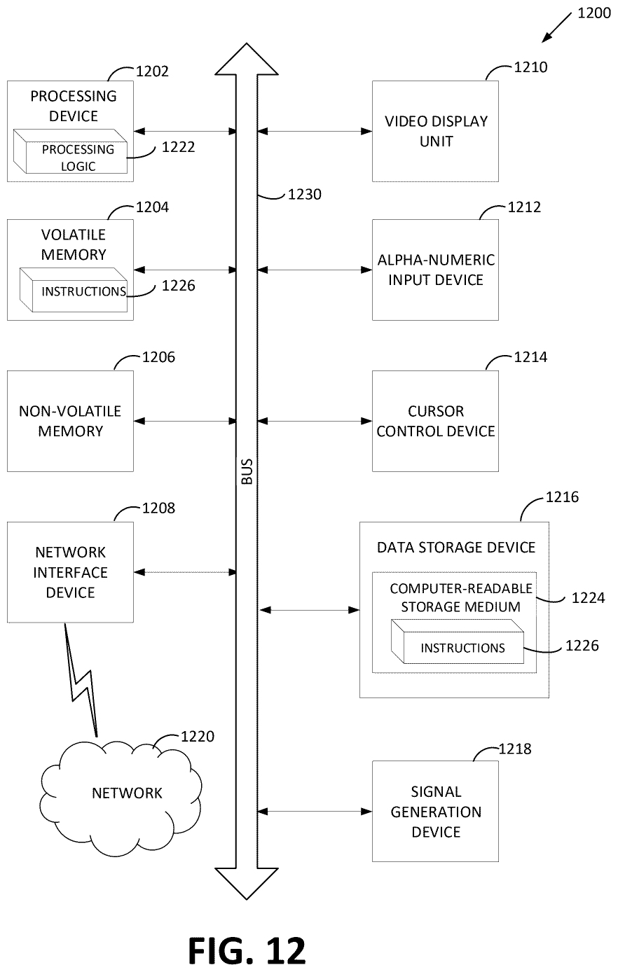

In some embodiments, system architecture 100 can include a computing system 102 hosting one or more virtualized systems (e.g., guests 120A, 120B, and/or 120C). Computing system 102 can correspond to one or more servers of a data center, in some embodiments. Computing system 102 can include one or more physical devices that can be used to support guests 120A, 120B, 120C (collectively and individually referred to as “guest 120” or “guests 120” herein). For example, computing system 102 can include one or more processing devices 104 (e.g., a central processing unit (CPU), a graphics processing unit, etc.) and/or a memory 106. One or more processing units can be embodied as processing device 104, which can be and/or include a micro-processor, digital signal processor (DSP), or other processing components. Memory 106 can include volatile memory devices (e.g., random access memory (RAM)), non-volatile memory devices (e.g., flash memory), storage devices (e.g., a magnetic hard disk, a Universal Serial Bus (USB) solid state drive, a Redundant Array of Independent Disks (RAID) system, a network attached storage (NAS) array, etc.), and/or other types of memory devices. It should be noted that even though a single processing device 104 is depicted in FIG. 1A, this is merely illustrative and in some embodiments, computing system 102 can include two or more processing devices 104. Similarly, in additional or alternative embodiments, computing system 100 can include two or more memory components, rather than a single memory component. Processing device 104 can be connected to memory 106 via a host bus. In some embodiments, one or more components of computing system 102 can correspond to computer device 1200 described with respect to FIG. 12.

As illustrated in FIG. 1A, system architecture 100 can include one or more devices 130A, 130B, 130C (individually and collectively referred to as “device 130” or “devices 130” herein). Device 130 can include any device that is internally or externally connected to another device, such as host system 102, and performs an input operation and/or an output operation upon receiving a request from the connected device. In some embodiments, device 130 can be a networking device, a storage device, a graphics processing device, and so forth. In additional or alternative embodiments, device 130 can host an emulation-capable device that is configured to expose one or more emulated devices each having a distinct interface type. Further details regarding emulation-capable devices are described with respect to FIG. 1B.

As indicated above, computing system 102 can host one or more virtualized systems 120. Virtualized systems 102 can include a virtual machine (e.g., a virtual runtime environment that emulates underlying hardware of a computing system) and/or a container (e.g., a virtual runtime environment that runs on top of an OS kernel and emulates an OS rather than underlying hardware), in some embodiments. Computing system 102 can execute a virtualization manager 108, which is configured to manage guests 120 running on computing system 102 (also referred to as “host system 102” or simply “host 102” herein). Virtualization manager 108 can be an independent component or part of an operating system 110 (e.g., a host OS), a hypervisor (not shown) or the like. A guest that represents a virtual machine can execute a guest OS 122 to allow guest software (one or more guest applications) to access virtualized resources representing the underlying hardware. A guest that represents a container virtualizes the host OS 110 to cause guest software (one or more containerized applications) to perceive that it has the host OS 110 and the underlying hardware (e.g., processing device 104, memory 106, etc.) all to itself.

Virtualization manager 108 can abstract hardware components of host system 102 and/or devices 130 and present this abstraction to guests 120. For example, virtualization manager 108 can abstract processing device 104 to guest 120A as guest processor(s) 124A, to guest 120B as guest processor(s) 124B, and/or to guest 120C as guest processor(s) 124C. Virtualization manager 108 can abstract processing device 104 for guest 120 by selecting time slots on processing device 104, rather than dedicating processing device 104 for guest 120, in some embodiments. In other or similar embodiments, virtualization manager 108 can abstract one or more portions of memory 106 and present this abstraction to guest 120A as guest memory 126A. Virtualization manager 108 can abstract one or more different portions of memory 106 and can present this abstraction to guest 120B as guest memory 126B and/or to guest 120C as guest memory 126C, in some embodiments. Virtualization manager 108 can abstract memory 106 by employing a page table for translating memory access associated with abstracted memory 126 with physical memory addresses of memory 106. During a runtime of an application instance at guest 120, virtualization manager 108 can intercept guest memory access operations (e.g., read operations, write operations, etc.) and can translate a guest memory address associated with the intercepted operations to a physical memory address at memory 106 using the page table.

As each of guests 120 are unlikely to consume the complete portion of memory 106 allocated by virtualization manager 108 at any one point in time, virtualization manager 108 can expose a larger amount of memory to each guest than is actually present in memory 106. For example, memory 106 can include volatile memory (e.g. RAM). Virtualization manager 108 can expose a larger amount of total memory space to guests 120A, 120B and 120C than is actually available in memory 106. In response to detecting that one or more of guests 120A, 120B, or 120C are attempting to access data of a memory page that does not currently reside at memory 106 (e.g., the memory page resides at a secondary storage of host system 102 (not shown)), virtualization manager 108 can remove another memory page from memory 106 (e.g., in accordance with a memory page eviction protocol, etc.) and can copy the memory page that includes the data to memory 106. Removing a memory page from memory 106 and copying another memory page into memory 106 is referred to as memory page swapping. Exposing a larger amount of memory to guests 120 than is actually present in memory 106 is referred to as memory overcommitment.

Virtualization manager 108 can abstract one or more devices and present this abstraction to guests 120 as virtual devices. For example, virtualization manager can abstract one or more of devices 130A, 130B, 130C and present this abstraction to guests 120A, 120B, and/or 120C as virtual devices 132A, 132B, 134A, 134B, 136A, and/or 136B, in some embodiments. Virtualization manager 108 can abstract a device by assigning particular port ranges to an interface slot of device 130 to a guest 120 and presenting the assigned port ranges as a virtual device (132, 134, and/or 136, in some embodiments. Guest 120 can utilize guest processor(s) 124, guest memory 126, and/or a virtual device 132, 134, 136 to support execution of an application, or an instance of an application, on guest 120.

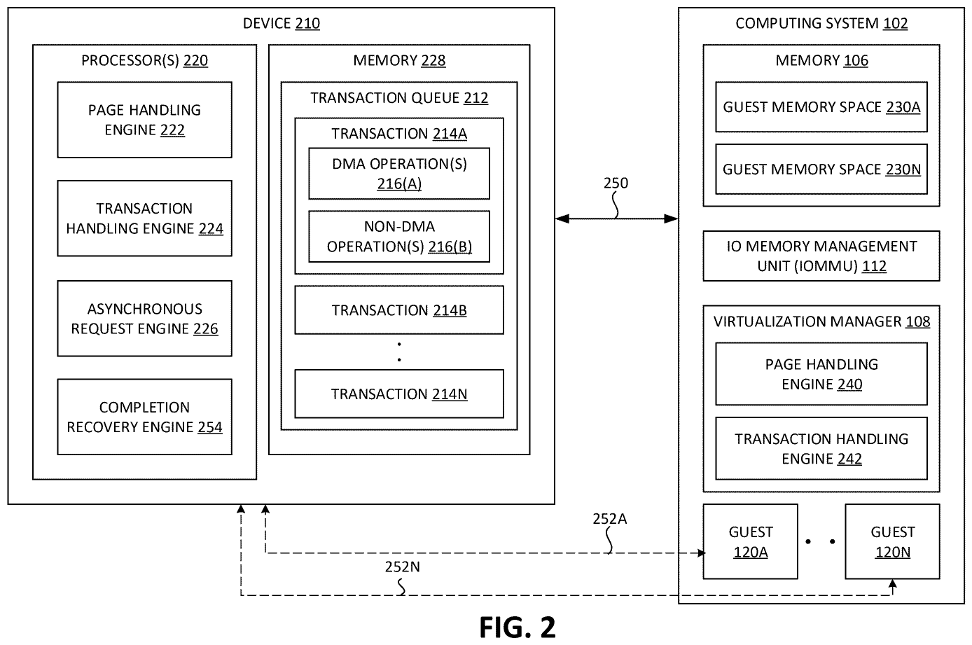

In some embodiments, one or more of devices 130A, 130B, and/or 130C can support direct memory access (DMA) of memory 106. DMA allows hardware (e.g., device 130, etc.) to access memory without involving a processing unit (e.g., processing device 104). Device 130 can access memory 106 by executing one or more DMA operations that reference a DMA memory address. In some embodiments, a DMA operation can include an operation to, at least one of, read data from a region of memory 106 associated with the DMA memory address, write data to a region of memory 106 associated with the DMA memory address, and so forth. A DMA operation can be an atomic operation, in some embodiments. Virtualization manager 108 can manage an input/output memory management unit (IOMMU) 112, which maintains mappings between DMA memory addresses (e.g., that are relevant to devices 130) and physical memory addresses of memory 106 (e.g., that are relevant to host system 102). In response to receiving a request to execute a DMA operation (e.g., of a transaction, as described further with respect to FIG. 2), the device can determine whether a memory page associated with a DMA memory address of the request is available at memory 106. In some embodiments, the memory page can correspond to a guest memory page. A memory page may not be available at memory 106 if: the data of the memory page is not stored at memory 106, the data of the memory page is present in memory 106, but a mapping for the memory page is not included at IOMMU 112, and/or the data of the memory page is present in memory 106 and a mapping for the memory page is included at IOMMU 112, but one or more permissions (e.g., read/write permissions, user/supervisor permissions, executable permissions, etc.) associated with IOMMU 112 prevent device 130 from accessing the mapping for the memory page. In other or similar embodiments, a memory page may not be available at memory 106 if the memory page is a read-only memory page and device 130 attempts to write data to the memory page, the memory page is a write-only memory page and device 130 attempts to read data from the memory page, the memory page is associated with virtualization manager 108 (or another supervisor entity associated with computing system 102 and/or another computing system) and device 130, which is permitted to access guest data, is attempting to access the memory page, and so forth.

In response to detecting that the memory page is not available at memory 106 (referred to as a page fault herein), device 130 can select a transaction fault handling protocol in view of one or more of characteristics of guest 120, properties of the transaction that includes the DMA operation, and/or prior transactions initiated at device 130. Device 130 can initiate the selected transaction fault handling protocol to address the page fault. In some embodiments, a transaction fault handling protocol can include one or more of rescheduling one or more operations (e.g., the DMA operation, another DMA operation, a non-DMA operation) of the transaction, terminating the DMA operation, and/or updating a memory address associated with the DMA operation to correspond to another memory address. Further details regarding selecting and initiating a transaction fault handling protocol are described with respect to FIG. 2.

In additional or alternative embodiments, device 130 can determine one or more memory pages that should be available at memory 106 (e.g., in accordance with DMA operations for future transactions). Device 130 can transmit a request to virtualization manager 108 to copy the one or more memory pages to memory 106 and update IOMMU 112 to include a mapping between a DMA memory address associated with the memory page(s) and a physical address for a region of memory 106 that stores the data of the memory page(s). In some embodiments, device 130 can transmit an additional or an alternative request to virtualization manager 108 to pin data of the one or more memory pages to the region of memory 106. As indicated above, pinning data to memory 106 refers to updating metadata associated with a memory page that includes the data to indicate that the data is not to be removed from the region of memory 106 (e.g., until a request is received to unpin the data, until a particular amount of time has passed, etc.). Further details regarding transmitting requests to virtualization manager 108 to make data available at memory 106 and/or pin data to memory 106 are described with respect to FIG. 2.

FIG. 1B is a block diagram of another example system architecture 150, according to at least one embodiment. As indicated above, in some embodiments, computing system 102 can be connected to one or more emulation-capable devices 180. An emulation-capable device 180 refers to a device including one or more components (referred to herein as emulation components) that can be configured to function as another type of device. In some embodiments, an emulation component can be implemented as a software component, a hardware component, or a combination of a software component and a hardware component (e.g., software executed by a processor of a device).

In some embodiments, emulation-capable device 180 can be configured to expose one or more emulated devices (e.g., emulated device 182A, emulated device 182B, etc.) to computing system 102. Each of emulated devices 182A, 182B (collectively and individually referred to as emulated device(s) 182 herein) can be associated with a distinct interface type that are exposed by emulation capable device 180 toward computing system 102. In an illustrative example, emulation capable device 180 can be a data processing unit (DPU) configured to expose an emulated processing unit (e.g., an emulated GPU, etc.), an emulated device having a non-volatile memory express (NVMe) interface, an emulated block device (e.g., a virtio-blk device, etc.), an emulated networking device (e.g., a virtio-net device), and/or an emulated network controller device (e.g., a network interface card (NIC)). In some embodiments, emulation-capable device 180 can be configured to expose native device interfaces (e.g., a NIC interface) and/or an emulated device interface (e.g., a NVMe interface). In additional or alternative embodiments, emulation-capable device 180 can be capable of supporting dynamic paging. Such emulation-capable device 180 can interpose dynamic paging capabilities for static paging devices (e.g., legacy devices). In an illustrative example, emulation-capable device 180 can reside at or otherwise be connected to computing system 102. One or more physical devices (e.g., device 130) can be connected to emulation-capable device 180. In such example, emulation-capable device 180 can expose one or more emulation interfaces to devices 130 and can mediate communication between computing system 102, guest 120, and/or devices 130. In some embodiments, such mediation can include transmitting data to and from guest 120 and handling page faults, in accordance with embodiments described herein. Emulation-capable device 180 can stage (e.g., pin) guest data at a particular region of physical memory associated with computing system 102. Device 130 can access the data from the stage region of the physical memory. Accordingly, guest data is exposed to directly to device 130 and device 130 is unaware of page faults, which are handled by emulation-capable device 180.

It should be noted that embodiments of the present disclosure can be applied with respect to one or more of devices 130 of FIG. 1A and/or one or more emulation-capable devices 180 of FIG. 1B. Embodiments that specifically relate to emulation-capable device 180 are highlighted herein. However, unless noted otherwise, it is to be understood that each embodiment of the present disclosure can be applied with respect to device(s) 130 and/or emulation-capable device(s) 180.

FIG. 2 is a block diagram of an example device 210 and an example computing system 100, according to at least one embodiment. Device 210 can correspond to any of devices 130A, 130B, or 130C described with respect to FIG. 1A, in some embodiments. In other or similar embodiments, device 210 can correspond to emulation capable device 180 described with respect to FIG. 1B. As illustrated in FIG. 2, device 210 can, in some embodiments, one or more processors 220 and/or a memory 228. Processor(s) 220 can include any type of processing unit that is configured to execute a logical operation. In some embodiments, processor(s) 220 can include one or more CPUs or any other type of processing unit. In some embodiments, processor(s) 220 can be a programmable extension of device 210 (e.g., processor(s) 220 are not exposed and/or otherwise accessible to computing system 102). In other or similar embodiments, processor(s) 220 can be a programmable extension one more components or modules of computing system 102 (e.g., processor(s) 220 are exposed and/or otherwise accessible to computing system 102). For example, processor(s) 220 can be a programmable extension to virtualization manager 108 and/or one or more of guests 120. Memory 228 can include volatile memory or non-volatile memory, in some embodiments. It should be noted that although FIG. 2 depicts memory 228 as a component of device 210, memory 228 can include any memory (e.g., internal or external to device 210) that is accessible by device 210.

In some embodiments, device 210 can receive requests to initiate one or more transactions. A transaction can, in some embodiments, involve execution of one or more operations, which can include DMA operations (e.g., to access data associated with one or more of guests 120) and/or non-DMA operations. Device 210 can receive transaction requests from one or more entities (referred to as transaction requestors herein). In some embodiments, the transaction requestor can include one or more components or modules executing at computing system 102 (e.g., guests 120, etc.). In other or similar embodiments, the transaction requestor can be an entity that is operating separately from computing system 102 (e.g., another computing system that can communicate with device 210 via a network or a system bus). Device 210 can service transactions of the received requests by executing one or more operations of the transaction. In some embodiments, device 210 can access data (e.g., read data, write data, erase data, etc.) associated with one or more entities (referred to as transaction targets herein) following completion of the execution of the one or more operations. A transaction target can be the same entity and/or can operate at the same computing system as a transaction requestor, in some embodiments. In other or similar embodiments, a transaction target can be different entities and/or can operate at a different computing system as the transaction requestor.

In at least one example, device 210 can be a transmitting (TX) network device (e.g., a TX Ethernet network device, etc.). In such example, device 210 can receive a request from one or more components or modules of computing system 102 (e.g., one or more of guests 120) to initiate a transaction associated with transmitting a data packet to a transaction target that does not reside at computing system 102 (e.g., another computing system). Device 210 can access data associated with the transaction from memory 106, in accordance with embodiments described herein, and can transmit the data packet to the transaction target. In at least another example, device 210 can be a receiving (RX) network device (e.g., a RX Ethernet network device, a RDMA network device, etc.). In such example, device 210 can receive a request from a transaction requestor that does not reside at computing system 102 to initiate one or more transactions associated with a data packet. Device 210 can execute one or more DMA operations (and/or RDMA operations) of the transaction to write data of the data packet to memory pages associated with one or more guests 120, in accordance with embodiments described herein. In yet at least another example, device 210 can be a data compression device (e.g., a data encoder device, etc.). Device 210 can receive a request from one or more components or modules of computing system 102 (e.g., one or more of guests 120) to initiate a transaction to compress data from memory pages (e.g., guest memory pages) of memory 106 and store the compressed data at memory 106. Device 210 can execute one or more DMA operations of the transaction to read data from memory pages of memory 106 and write the compressed data to memory pages of memory 106, in accordance with embodiments described herein. In yet another example, device 210 can be a block write device. Device 210 can receive a request from one or more components or modules of computing system 102 (e.g., one or more of guests 120) to initiate a transaction to read data and/or metadata (e.g., an operation descriptor) from memory pages (e.g., guest memory pages) memory 106 and write a completion status of the read data and/or metadata to memory 106. Device 210 can execute one or more DMA operations to read data and/or metadata form the memory pages of memory 106 and write the completion status to memory pages of memory 106, in accordance with embodiments described herein. It should be noted that the examples provided above are for illustrative purposes only. Device 210 can be another type of device and/or can receive requests to initiate other types of transactions from entities residing at computing system 102 and/or other computing systems, in accordance with embodiments of the present disclosure.

Device 210 can maintain a transaction queue 212, in some embodiments. As illustrated in FIG. 2, transaction queue 212 can reside at one or more portions of memory 228, in some embodiments. For example, one or more portions of memory 228 can include memory buffers that are allocated at transaction queue 212. In other or similar embodiments, transaction queue 212 can reside at another portion of device 210 (e.g., outside of memory 228). In yet other or similar embodiments, transaction queue 212 can reside at a portion of memory 106 (e.g., at guest memory 230, described below, etc.). In response to receiving a request to initiate a transaction, device 210 can add the transaction to transaction queue 212 (e.g., as transaction 214). In some embodiments, device 210 can add transaction 214 to transaction queue 212 in accordance with a priority and/or an ordering associated with the transaction 214, or other transactions 214 of transaction queue 212. For example, device 210 can add transactions 214B and/or 214N to transaction queue 212 before a request to initiate transaction 214A is received. However, device 210 can determine that transaction 214A is associated with a higher priority than transactions 214B and/or 214N (e.g., in view of metadata received with the request, in view of a status associated with the transaction requestor, etc.) and can add transaction 214A at a position such that transaction 214A will be addressed before transactions 214B and/or 214N.

In other or similar embodiments, a transaction requestor can add a transaction 214 to transaction queue 212. For example, transaction queue 212 can reside at memory 106 (e.g., at a portion of guest memory space 230A, 230N, etc., as described below, etc.). The transaction requestor can add the transaction 214 to transaction queue 212 at guest memory space 230 and one or more components of computing system 102 (e.g., virtualization manager 108) can transmit a notification to device 210 indicating that transaction 214 is added to transaction queue 212. The notification can be provided directly via a memory management IO (MMIO) access, in some embodiments. For example, guest 120 can transmit a request to write data to guest memory space 230. A memory management unit (MMU) controlled by virtualization manager 108 (not shown) can translate the write request to a PCIe request (or another type of communication protocol request), in some embodiments. The MMU can therefore access the device 210 directly (e.g., via the PCIe request) without intervention by virtualization manager 108. Once the request is received, device 210 can access guest memory space 230 and can initiate operations of transaction 214 (e.g., in accordance with embodiments described herein).

In other or similar embodiments, device 210 (e.g., a RX networking device) can have access to (e.g., either at memory 228 or at memory 106) multiple transaction queues 212 that are each associated with a transaction target (or a network address associated with a transaction target). In one or more examples, when a network packet is received, device 210 can parse the network packet of the transaction 214 to determine a network address associated with the transaction target and can add the transaction 214 to a queue 212 associated with the transaction target. Once the transaction 214 is added to a queue 212, the operations of the transaction 214 can be executed, as described herein. In accordance with the previous one or more examples, operations of the transaction 214 can involve scattering data of the network packet across one or more buffers (e.g., indicated by the one or more parameters for the network packet) at device 210. It should be noted that device 210 (or another entity associated with system architecture 100) can add a transaction 214 to a transaction queue 212, in accordance with other or similar embodiments.

It should be noted that although FIG. 2 depicts transaction queue 212 as a single queue, transaction queue 212 can include one or more queues, in some embodiments. In other or similar embodiments, one or more portions of transaction queue 212 can be configured to store different types of transactions 214. For example, if device 210 is a networking device (e.g., a TX networking device, a RX networking device, etc.), a first portion of transaction queue 212 can be configured to store transactions 214 that are received from a first entity and a second portion of transaction queue 212 can be configured to store transactions 214 that are received from a second entity.

As indicated above, a transaction 214 can involve executing one or more DMA operations 216A and/or one or more non-DMA operations 216B. In accordance with previously described examples and embodiments, the one or more DMA operations can involve accessing data of memory pages residing at space of memory 106 that is allocated to guest 120A (e.g., guest memory space 230A of memory 106) and/or guest 120N (e.g., guest memory space 230N of memory 106). Page handling engine 222 can attempt to access the guest memory page(s) that include the data by executing the one or more DMA operations 216A. In some embodiments, data (or metadata) of transaction 214 can indicate a DMA memory address associated with executing a DMA operation 216A. Accordingly, device 210 can determine the DMA memory address for the DMA operation 216A in view of the data (or metadata) of transaction 214.

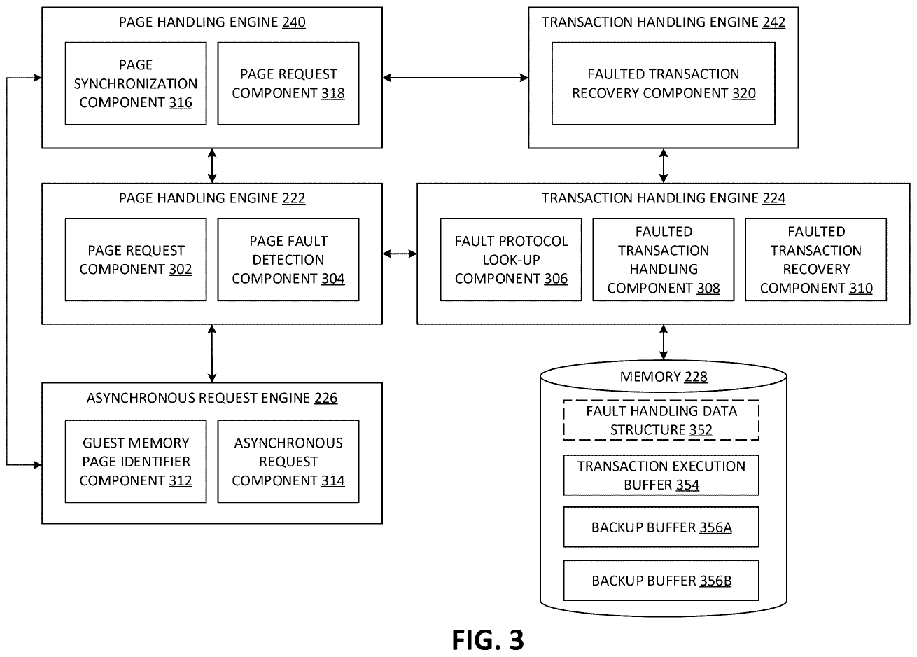

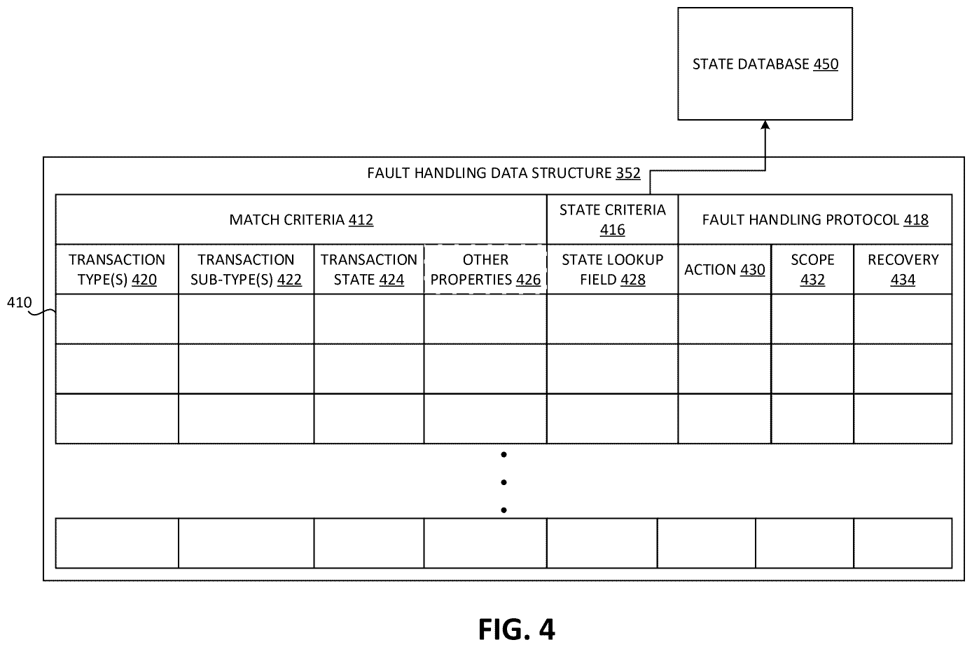

In some embodiments, the data of the guest memory page(s) is not available at memory 106 at the time the one or more DMA operations are executed (e.g., the data is stored at secondary storage, etc.). As indicated above, such occurrence is referred to herein as a page fault. In response to page handling engine 222 detecting a page fault, transaction handling engine 224 can select a transaction fault handling protocol to address the page fault. In some embodiments, transaction handling engine 224 can select the transaction fault handling protocol using a fault handling data structure, such as fault handling data structure 352 of FIGS. 3 and 4. Transaction handling engine 224 can select the transaction fault handling protocol according to other techniques, in other or similar embodiments. Further details regarding selecting and initiating a transaction fault handling protocol to address a detected page fault are described herein.

As illustrated in FIG. 2, device 210 can also include an asynchronous request engine 226. Asynchronous request engine 226 can evaluate transactions 214 added to transaction queue 212 and can identify one or more memory pages (e.g., guest memory pages) that are to be involved during execution of operations 216 of the transactions 214. In some embodiments, asynchronous request engine 226 can transmit one or more requests to virtualization manager 108 to make data of guest memory pages that are to be involved during execution of operations 216 available at memory 106. In additional or alternative embodiments, asynchronous request engine 226 can transmit one or more requests to virtualization manager 108 to pin one or more guest memory pages to memory 106, as described above. Further details regarding asynchronous request engine 226 are described above.

Virtualization manager 108 can also include a page handling engine 240 and/or a transaction handling engine 242, in some embodiments. Page handling engine 240 can be configured to make data of a guest memory page available at memory 106 (e.g., copy the data from secondary storage to memory 106, etc.). In some embodiments, page handling engine 240 can make the data of the guest memory page available at memory 106 in response to a request from page handling engine 222 and/or asynchronous request engine 226 of device 210. Page handling engine 240 can also generate a mapping between a DMA address associated with a guest memory page (e.g., as indicated in a request received from page handing engine 222 and/or asynchronous request engine 226) and a physical address associated with a region of memory 106 that includes the guest memory page, in some embodiments. Page handling engine 240 can update IOMMU 112 to include the generated mapping. In additional or alternative embodiments, page handling engine 240 can pin guest memory pages to memory 106 by updating metadata associated with the guest memory pages (e.g., at memory 106, at IOMMU 112, etc.) to indicate that data of the guest memory pages is not to be removed from memory 106. Page handling engine 222 can pin the guest memory pages in response to a request from page handling engine 222 and/or asynchronous request engine 226, in some embodiments. Page handling engine 222 can similarly unpin guest memory pages at memory 106 by updating the metadata to indicate that the data of the guest memory pages can be removed from memory 106. Further details regarding page handling engine 222 are described herein. Transaction handling engine 242 of virtualization manger 108 can be configured to execute operations associated with a transaction fault handling protocol selected by transaction handling engine 224, in some embodiments. Further details regarding transaction handling engine 242 are described herein. It should be noted that although FIG. 2 depicts page handling engine 240 and transaction handling engine 242 as components of virtualization manager 108, page handling engine 240 and/or transaction handling engine 242 can be components of other engines or modules executing at computing system 102.

In some embodiments, device 210 can be an integrated component of computing system 102. In other or similar embodiments, device 210 can be an external component to computing system 102. As illustrated in FIG. 2, device 210 can be connected to computing system 102 via connection 250. In some embodiments, connection 250 can include a system bus. For example, connection 250 can correspond to at least one of a peripheral component interconnect express (PCIe) interface, a commute express link (CXL) interface, a die-to-die (D2D) interconnect interface, a chip-to-chip (C2C) interconnect interface, a graphics processing unit (GPU) interconnect interface, or a coherent accelerator processor interface (CAPI). In some embodiments, device 210 can be a root complex integrated endpoint device. In such embodiments, connection 250 can be exposed (e.g., to guest 120, etc.) as a PCIe/CXL interface, even though connection 250 may not be a PCIe interface. In other or similar embodiments, connection 250 may be associated with a non-standard connection protocol. In yet other or similar embodiments, connection 250 can be a connection over a network (e.g., a public network, a private network, a wired network, a cellular network, and/or a combination thereof). As also illustrated in FIG. 2, device 210 can communicate with each of guests 120 hosted by computing system 102. In some embodiments, device 210 can communicate with guests 120 via a virtual connection 252 (e.g., a virtual bus, etc.). For example, device 210 can communicate with guest 120A via first virtual connection 252A and with guest 120N via a second virtual connection 252N. Virtualization manager 108 can abstract hardware components of computing system 102 (e.g., system bus between device 210 and computing system 102) and present such abstraction to guests 120 as virtual connections 252, in accordance with previously described embodiments.

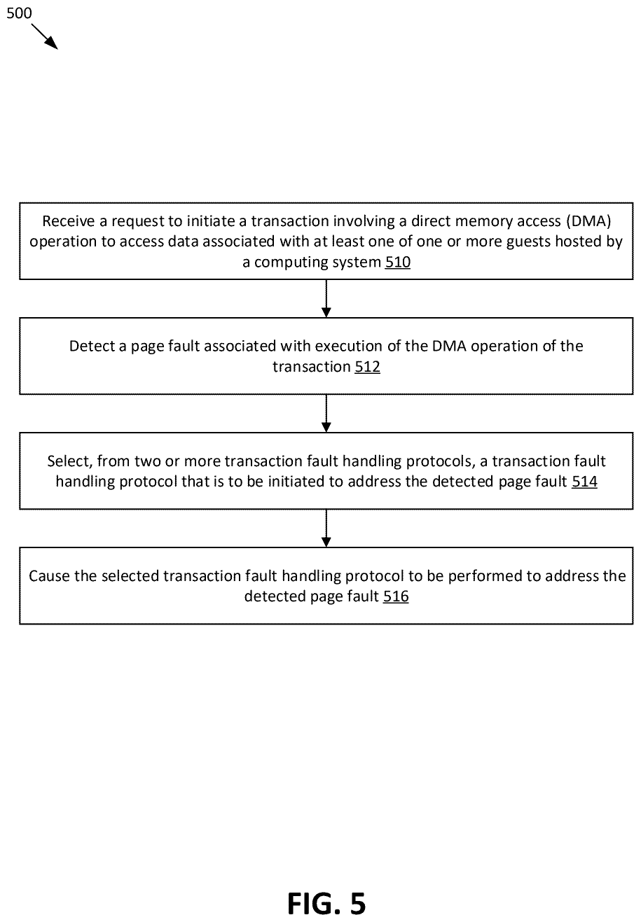

FIG. 3 illustrates a block diagram of one or more engines associated with a fault resilient transaction handling device, according to at least one embodiment. FIG. 4 illustrates an example fault handling data structure 352, according to at least one embodiment. Details regarding the one or more engines associated with the fault resilient transaction handling device and the example fault handling data structure are provided below with respect to FIG. 5.

FIG. 5 illustrates a flow diagram of an example method 500 of for handling page faults at a fault resilient transaction handling device, according to at least one embodiment. In some embodiments, one or more operations of example method 500 can be performed by one or more components of FIG. 3, as described herein. Method 500 can be performed by processing logic that can include hardware (circuitry, dedicated logic, etc.), software (e.g., instructions run on a processing device), or a combination thereof. In one implementation, some or all of the operations of method 500 can be performed by device 210. For example, some or all of the operations of method 500 can be performed by one or more components of page handling engine 222 and/or transaction handling engine 224 (e.g., residing at device 210), as described herein.

At block 510, processing logic receives a request to initiate a transaction involving a DMA operation to access data associated with at least one of one or more guests hosted by a computing system. As described with respect to FIG. 2, device 210 can receive a request to initiate a transaction 214 that includes one or more DMA operations 216A to access data at one or more guest memory pages residing at memory 106. Page request component 302 of page handling engine 222 can determine a DMA memory address associated with the data and can execute one or more DMA operations 216A to access the data at the region of memory associated with the DMA memory address. In some embodiments, page request component 302 can determine the DMA memory address based on information included in the received request. In other or similar embodiments, page request component 302 can determine the DMA memory address using one or more data structures that store information associated with DMA accessible guest data and are accessible by device 210. Page request component 302 can determine the DMA memory address according to other techniques, in additional or alternative embodiments.

Referring back to FIG. 5, at block 512, processing logic detects a page fault associated with execution of the DMA operation of the transaction (e.g., DMA operations 216A). Page request component 302 of page handling engine 222 can execute the one or more DMA operations 216A to attempt to access the data of the request at one or more guest memory pages associated with the DMA address. If the data of the guest memory page(s) is available at memory 106, page request component 302 can access the data and can complete the DMA operation(s) 216A (and/or the non-DMA operation(s) 216B) to complete the transaction 214 in accordance with the request. If, however, the data of the guest memory page(s) is not available at memory 106, page fault detection component 304 of page handling engine 222 can detect a page fault. In some embodiments, a page fault may occur because a DMA memory address (or access permissions and/or privileges) associated with the data of the request is not accurate, even if the data is available at memory 106. For example, a mapping associated with the guest memory page(s) at IOMMU 112 may not include an up to date DMA memory address. In such embodiments, page request component 302 can transmit a request to page synchronization component 316 of page handling engine 240. Page synchronization component 316 can update the mapping associated with the guest memory page(s) at the IOMMU 112 to include the up to date DMA memory address. Page request component 302 can access the data of the guest memory page(s), as described above, responsive to receiving confirmation from page synchronization component 316 has updated the IOMMU 112 to include the updated mapping. Although the above embodiments provide that page synchronization component 316 updates mappings at the IOMMU 112 to include up to date DMA memory addresses in response to a request from page request component 302, page synchronization component 316 can update the mappings at IOMMU 112 asynchronously (e.g., without receiving a request), in some embodiments. For example, page synchronization component 316 can remove a mapping from IOMMU 112, in some embodiments. When a page mapping is removed from IOMMU 112, page synchronization component 316 can notify page request component 302 and/or page fault detection component 304 that the page mapping is unavailable.

Referring back to FIG. 5, at block 514, processing logic selects, from two or more transaction fault handling protocols, a transaction fault handling protocol that is to be initiated to address the detected page fault. As a faulted DMA operation 216A is part of a transaction 214, the transaction 214 that includes the faulted DMA operation 216A is also considered to have faulted. In response to detecting that a transaction fault has occurred for a transaction 214, fault protocol look-up component 306 can select a transaction fault handling protocol that is to be initiated to address the transaction fault and the corresponding page fault. In some embodiments, fault protocol look-up component 306 can select a transaction fault handling protocol from multiple different transaction fault handling protocols associated with system architecture 100. A transaction fault handling protocol associated with system architecture 100 can involve rescheduling one or more operations (e.g., the faulted DMA operation 216A, another DMA operation 216A, a non-DMA operation 216B) at device 210, terminating the one or more operations of the transaction, and/or updating a DMA memory address associated with the faulted DMA operation 216A and/or another DMA operation 216A to correspond to another DMA memory address. Further details regarding the transaction fault handling protocols are provided herein. For purposes of example and illustration only, embodiments described below may refer to transaction 214A as a faulted transaction and transactions 214B-N as other transactions. It should be noted, however, that any of transactions 214 can be a faulted transaction and/or another transaction, in accordance with embodiments and examples described herein.

In some embodiments, fault protocol look-up component 306 can select a transaction fault handling protocol to address faulted transaction 214A and the corresponding page fault in view of one or more match criteria. The match criteria can be based on state and/or stateless properties and can include characteristics associated with one or more guests 120 (e.g., the guest 120 associated with the guest memory page(s) involved in the page fault, etc.), properties of faulted transaction 214A, and/or properties of one or more prior transactions 214 initiated at the device 210. Characteristics associated with a guest 120 can refer to one or more types of applications running on the guest 120, a state of an application running on the guest 120, a type associated with the guest 120 (e.g., whether guest 120 is a virtual machine or a container), one or more security settings or protocols associated with the guest 120 (e.g., whether guest 120 is an encrypted guest or an un-encrypted guest, encryption protocols associated with the guest 120, etc.), and so forth. Properties of a transaction 214 (e.g., either the faulted transaction 214A and/or the one or more prior transactions 214) can refer to a type associated with the transaction 214 (e.g., whether the transaction 214 is a transmit (TX) networking transaction, a receiving (RX) networking transaction, a compression transaction, a work queue transaction, a completion queue transaction, etc.), a protocol associated with the transaction 214, a type of data associated with the transaction (e.g., whether a TCP networking packet of a transaction 214 is a TCP control packet or a TCP data packet, etc.), a context affiliation of the transaction 214, a queue affiliation of the transaction 214, a guest affinity of the transaction 214, and so forth. As described above, device 210 can be an emulation capable device that is configured to expose multiple emulated devices each having distinct interface types to a host system. In such embodiments, properties of a transaction can additionally or alternatively include a sub-type associated with the transaction 214, where the transaction sub-type refers to a type of the distinct interface associated with an emulated device exposed by the emulation capable device. In other or similar embodiments, device 210 can expose multiple sets of functionalities to computing system 102 (with or without emulation). A transaction sub-type can additionally or alternatively refer to a type of functionality offered by a single device 210 (e.g., a data copy functionality, a data compression functionality, a data encryption functionality, etc.) that is associated with the transaction 214. In yet other or similar embodiments, device 210 can support multiple interfaces. A transaction sub-type can additionally or alternatively refer to a type of interface that is associated with the transaction 214. Properties of prior transaction(s) 214 can also refer to a number of prior transaction(s) 214 that have faulted at device 210, in some embodiments.

In additional or alternative embodiments, fault protocol look-up component 306 can be selected in view of one or more state criteria associated with device 210. State criteria refers to a state of one or more entities of system architecture 100. In some embodiments, state criteria can include a state of device 210, a state of guest 120, a state of computing system 102, a state of a connection between two or more entities of system architecture 100, etc. (referred to herein as global state criteria). In other or similar embodiments, state criteria can include a state of one or more transactions 214 at transaction queue 212 and/or prior transaction(s) 214 initiated at device 210 (referred to herein as transaction state criteria). For example, state criteria for a transaction can include an execution state for the faulted transaction 214A and/or other transactions 214 at the transaction queue (e.g., whether the transaction 214 has been initiated, is executing, is completed, etc.), a fault state for the faulted transaction 214A and/or the prior transaction(s) 214, and so forth. In yet other or similar embodiments, state criteria can include a state of a subset (e.g., one or more operations) of a transaction 214 (referred to as transaction subset state criteria). State criteria can be related to faulted transaction 214A and/or other faulted transactions at device 210, in some embodiments. In other or similar embodiments, state criteria may not be related to faulted transaction 214A and/or another faulted transaction at device 210. In additional or alternative embodiments, state criteria can refer to an availability of one or more buffers (e.g., backup buffer 356A, 356B, etc.) associated with device 210. Fault protocol look-up component 306 can determine state criteria associated with device 210 that is to be considered with the match criteria using a state database, as described in further detail herein.

In some embodiments, fault protocol look-up component 306 can select the transaction fault handling protocol to be initiated to address the transaction fault and corresponding page fault. In some embodiments, fault protocol look-up component 306 can select the transaction fault handling protocol using a fault handling data structure 352. In some embodiments, fault handling data structure 352 can reside at memory 228 of device 210. Fault handling data structure 352 can be stored at memory 228 during an initialization of device 210, in some embodiments. In additional or alternative embodiments, fault handling data structure 352 may not reside at memory 228 and instead can reside at other memory associated with system architecture 100 (e.g., at memory 106, at another memory of computing system 102 and/or another computing system, etc.). In such embodiments, device 210 can access fault handling data structure 352 (e.g., via connection 250, via a network, etc.) in accordance with embodiments described herein.

FIG. 4 illustrates an example fault handling data structure 352, according to at least one embodiment. Fault handling data structure 352 can be any type of data structure that is configured to store one or more data items. In an illustrative example, fault handling data structure 352 can be a table, as illustrated in FIG. 4A. It should be noted, however, that fault handling data structure 352 may not be a table and may be any other type of data structure that can store data items, in some embodiments.

As illustrated in FIG. 4, fault handling data structure 352 can include one or more entries 410. Each entry 410 can include fields 412 indicating one or more match criteria and fields 418 indicating a fault handling protocol that is to be initiated to handle transaction faults (and corresponding page faults) in view of the match criteria. Match criteria fields 412 can include one or more fields that include information associated with match criteria, as indicated above. For example, match criteria fields 412 can include fields associated with characteristics of guests 120, properties of the faulted transaction 214, and/or properties of one or more prior transactions 214 initiated at device 210. In an illustrative example, match criteria fields 412 can include, as illustrated in FIG. 4, a transaction type field 420 (e.g., to include information about a type of a transaction 214), a transaction sub-type field 422 (e.g., to include information about a sub-type of the transaction 214, and/or one or more additional fields 426 to (e.g., to include information relating to other match criteria, such as guest characteristics, emulated device characteristics, etc.). In some embodiments, state criteria for a transaction 214 can depend on one or more match criteria for the transaction. Accordingly, match criteria fields 412 can include a transaction state field 424 (e.g., to include information relating to a state of a transaction 214 or one or more prior transactions 214). In additional or alternative embodiments, state criteria for a transaction 214 can be independent from match criteria for the transaction 214. Accordingly, entries 410 can include one or more state criteria 416, which include information relating to state criteria, as indicated above. Information included in any of match criteria fields 412 may be referred to herein as match criteria 412. Information included in state criteria field 416 may be referred to herein as state criteria 416.

In additional or alternative embodiments, state criteria fields 416 may not indicate one or more state criteria associated with device 210 and instead may include a state lookup field 428. State lookup field 428 can indicate a type of state data that is to be accessed and/or a technique that is to be used to determine state criteria associated with device 210, in some embodiments. The state criteria that is determined in view of the information included in state lookup field 428 can be considered (e.g., with match criteria 412) to select a fault handling protocol 418 that is to be used to address the faulted transaction 214, as described herein. In some embodiments, information of state lookup field 428 can indicate one or more state databases 450 that include state data associated with device 210, guest 120, computing system 102, a connection between two or more entities of system architecture 100, and so forth. Data included at state databases 450 can correspond to global state criteria and/or transaction state criteria, in some embodiments.

Fault handling protocol fields 418 can include one or more of an action field 430, a scope field 432, and/or a recovery field 434. Action field 430 can include an indication of an action that can be taken to address the transaction fault and corresponding page fault. As indicated above, an action of a respective transaction fault handling protocol can involve rescheduling one or more operations 216 of the faulted transaction 214A (or another transaction 214B-N) at device 210 (referred to herein as a rescheduling action), terminating one or more operations 216 of the faulted transaction 214A (referred to herein as a termination action), and/or updating a DMA memory address associated with the faulted DMA operation 216A or another DMA operation 216A to correspond to another DMA memory address (referred to herein as a reassociation action). Action field 430 can include an indication of a type of action that is to be taken to address a faulted transaction 214A in view of match criteria for that transaction (e.g., as indicated by match criteria fields 412) and/or state criteria (e.g., as determined in view of information indicated by state lookup field 416).

Rescheduling one or more operations 216 of a faulted transaction 214A (or another transaction 214B-N) at device 210 can involve attempting to re-execute the one or more operations 216 at a subsequent time period. In some embodiments, device 210 can reschedule the one or more operations 216 to be executed at (or subsequent to) a time period when a request to access a memory page that caused the page fault is transmitted to computing system 102. In some embodiments (e.g., to perform operations associated with a rescheduling action, when a notification indicating that a page fault has been handled is received, etc.), device 210 may block operations 216 of the faulted transaction 214A, operations 216 of a portion of transactions 214 at transaction queue 212, or operations 216 of all transactions 214 at transaction queue 212 (e.g., in view of match criteria for the faulted transaction 214). Action field 430 for an entry 410 having particular match criteria can indicate whether operations 216 of the faulted transaction 214A and/one or more of the other transactions 214B-N at transaction queue 212 are to be blocked until the faulted transaction 214A is handled (e.g., the causing page fault is resolved). If action field 430 of the entry 410 indicates that a portion of transactions 214 at transaction queue 212 are to be blocked, action field 430 can further indicate which transactions (e.g., transactions 214 having a particular type, transactions 214B-N received within a certain time following the faulted transaction 214A, etc.) are to be blocked. In an illustrative example, an entry 410 having match criteria indicating that a type of device 210 is a transmitting (TX) networking device (e.g., a TX NIC) can have an action field 430 that indicates, to address a faulted transaction 214A, device 210 is to block transactions 214 at a portion of transaction queue 212 (e.g., corresponding to a send queue) until the faulted transaction 214A is handled, but transactions 214B-N at other portions of transaction queue 212 (e.g., corresponding to one or more other send queues) can be initiated before or while the faulted transaction 214A is handled. In another illustrative example, an entry 410 having match criteria indicating that a type of device 210 is a block device or a compression device can have an action field 430 that indicates that operations 216 of a faulted transaction are to be blocked until the faulted transaction 214A is handled, but operations 216 of other transactions 214B-N at transaction queue 212 (e.g., subsequent transactions 214) can be initiated before or while the faulted transaction 214A is handled.

As indicated above, a terminating action can involve terminating one or more operations of the faulted transaction 214A and/or the other transactions 214B-N. In some embodiments, to perform operations associated with a terminating action, device 210 may or may not notify a transaction requestor and/or a transaction target that one or more operations 216 of the faulted transaction 214 are terminated and/or successfully completed. Action field 430 for an entry having particular match criteria 412 and/or state criteria 416 can indicate whether a requestor of a faulted transaction 214A (or another entity) is to be notified of the termination. In an illustrative example, an entry 410 having match criteria 412 indicating that a type of the transaction 214 is an inbound network packet can have an action field 430 that indicates that the transaction is to be dropped and no notice is to be given to the transaction requestor. In another illustrative example, an entry 410 having a match criteria 412 indicating that a type of the device 210 is a RDMA networking device can have an action field 430 that indicates that operations involving a RDMA read response and/or subsequent inbound transactions 214 are to be dropped and no notice is to be given to the transaction requestor. The action field 430 can further indicate that a read request and/or the subsequent transactions are to be retransmitted by the device 210 and that such protocol is to be repeated until a threshold number of transactions are retransmitted. The action field 430 can indicate that if a threshold number of transactions are retransmitted, a notification of error completion will be issued to the transaction requestor and/or the transaction target. In yet another illustrative example, an entry 410 having a match criteria 412 indicating that a type of the device 210 is a compression device can have an action field 430 that indicates that device 210 is to notify the requestor and/or the target that a portion of the DMA operations 216A of the faulted transaction 214 has completed successfully (e.g., a portion of data of the transaction has been compressed). In yet another illustrative example, an entry 410 having a match criteria 412 indicating that a type of the device 210 is a storage device can have an action field 430 that indicates that device 210 is to notify the requestor and/or the target that data has not been written to memory 106 following a page fault for the transaction 214. In yet another illustrative example, an entry 410 having a match criteria 412 indicating that a type of the device 210 is a RDMA networking device can have an action field 430 that indicates that device 210 is to transmit a notification to a requestor of a faulted transaction 214A indicating that the requestor is to re-transmit the request at a later time. In some embodiments, the action field 430 can further indicate that the device 210 is to notify the requestor of an amount of time that the requestor is to wait before re-transmitting the request. Such amount of time can be dependent on a severity of the page fault, in some embodiments. In an additional or alternative example, the action field 430 can indicate that device 210 is to notify the requestor of the faulted transaction 214 but is not to instruct the requestor to re-transmit the request.

As indicated above, a reassociation action can involve reassociating a DMA memory address for a memory page that caused a page fault with another DMA memory address. For example, a transaction requestor can request to write data to one or more guest memory pages associated with a particular DMA memory address. A reassociation action can involve determining one or more other guest memory pages (e.g., that are available at memory 106) that are associated with another DMA memory address and writing the data to the other guest memory pages via one or more DMA operations 216A. In some embodiments, action field 430 can indicate one or more alternative DMA memory addresses that are to be used to perform the reassociation action. For example, action field 430 can indicate one or more backup DMA memory addresses that are to be used to perform the reassociation action in response to a faulted transaction 214A having one or more particular match criteria 412 and/or state criteria 416. Such backup DMA memory addresses can be associated with a backup memory buffer (e.g., residing at memory 228, residing at memory 106, residing at another memory of system architecture 100, etc.), in accordance with embodiments described herein. A backup memory buffer can be managed by the transaction requestor, the transaction target, device 210, and/or one or more components of computing system 102 (e.g., virtualization manager 108), in some embodiments.

In other or similar embodiments, action field 430 can indicate that alternative DMA memory address can be determined in view of data (or metadata) associated with a faulted transaction 214A. For example, a transaction 214 received by a RX networking device can include an indication of multiple operations 216. A packet can be received by the RX networking device, which, upon receipt, can initiate execute of one or more operations of the RX transaction 214 based data of the received packet. An entry 410 having match criteria 412 indicating that a type of the device 210 is a RX networking device can have an action field 430 that indicates that device 210 is to determine the packet of the transaction (e.g., transaction 214A) is to be reassociated with another transaction (e.g., transaction 214B). By reassociating the packet with transaction 214B, DMA memory addresses associated with the packet are updated in view of transaction 214B. In some embodiments, a transaction skip protocol can indicate a number of times that a packet (e.g., a packet associated with transaction 214A, another packet, etc.) can be reassociated with another transaction. For example, the protocol can indicate a total number of transactions that can be skipped, a number of transactions that can be skipped within a particular time frame, and so forth.

After a faulted transaction is handled, the device can transmit a notification (e.g., to the transaction requestor, to the transaction target, etc.) indicating the status of the transaction. In accordance with the previous examples, the RX networking device can transmit a notification indicating that the transaction has been skipped (e.g., in accordance with a transaction skip protocol). The RX networking device can transmit the notification when the transaction fault is detected or after the transaction fault is handled. In some embodiments, the RX networking device can indicate (e.g., in the notification) that the transaction requestor is to reissue the transaction in view of the skipped transaction. In other or similar embodiments, the RX networking device may not transmit a notification to the transaction requestor. Instead, the RX networking device can reuse the faulted transaction (e.g., after the fault is handled) for an incoming packet.

In some instances, the action field 430 can indicate whether a notification is to be transmitted to the transaction requestor and/or the transaction target indicating the DMA memory address associated with the faulted guest memory page. In other or similar instances, the action field 430 can indicate whether the DMA memory address associated with the faulted guest memory page is to be used to buffer data of subsequent transactions 214 (e.g., after the page fault is resolved).

In some embodiments, action field 430 of an entry 410 can indicate that a reassociation action is to be taken if a buffer associated with a backup or alternative DMA memory address is available (e.g., at memory 106, at memory 228, etc.). Action field 430 of the entry 410 can indicate that, if the associated buffer is not available, an alternative action (e.g., a termination action, a rescheduling action, etc.) is to be taken. State criteria field 416 and/or information indicated by state lookup field 428 of such entry 410 can indicate a state of a buffer associated with the backup or alternative DMA memory address (e.g., a backup buffer, etc.), in some embodiments.

As illustrated in FIG. 4, fault handling protocol fields 418 can include a scope field 432. The scope field 432 of an entry 410 can include an indication of a scope of the action, indicated by action field 430, that is to be taken to address a page fault and a corresponding faulted transaction 214A. In some embodiments, the action taken to address a faulted transaction 214A can be taken with respect to the DMA operation 216A that caused or otherwise resulted in the corresponding page fault. However, one or more additional operations 216 (e.g., additional DMA operations 216A, non-DMA operations 216B) and/or one or more additional transactions 214 (e.g., transactions 214B-N) can be impacted by faulted transaction 214A. Information indicated by scope field 432 of an entry 410 can indicate whether the action indicated by action field 430 (and/or an additional or alternative action) is to be performed with respect to the one or more additional operations 216 and/or the one or more additional transactions 214 at transaction queue 212, in some embodiments.

As indicated above, a transaction 214 can involve multiple DMA operations 216A. In some embodiments, one or more DMA operations 216A of the transaction 214 can succeed (e.g., no page fault occurs during execution of the DMA operation(s) 216A), while other DMA operations 216A of the transaction 214 can fail (e.g., a page fault occurs during execution of the DMA operation(s) 216A). For example, a faulted transaction 214A can correspond to an inbound network packet (e.g., an Ethernet jumbo frame packet) that is received by device 210 (e.g., a networking device). Transaction 214A can include three DMA operations 216A each associated with a distinct DMA memory address. Scope field 432 of an entry 410 having a corresponding match criteria 412 can indicate whether an action (indicated by action field 430 of the entry 410) is to be taken with respect to a faulted DMA operation 216A (e.g., the DMA operation 216A that caused the page fault and corresponding transaction fault), the faulted DMA operation 216A as well as the subsequent DMA operations 216A, or each DMA operation 216A of the transaction 214A. If a termination action is to be taken with respect to one or more of the DMA operations 216A, a scope field 432 and/or action field 430 of the corresponding entry 410 can indicate whether a notification regarding the successful and/or faulted DMA operations 216A is to be transmitted to the transaction requestor and/or the transaction target, as described above. If a reassociation action is to be taken with respect to one or more of the DMA operations 216A, the scope field 432 and/or the action field 430 of the corresponding entry 410 can indicate whether the faulted DMA operations 216A are to be reassociated with a backup or alternative DMA memory address or one or more additional DMA operations 216A are to be reassociated with backup or alternative DMA memory addresses, as described above. The scope field 432 and/or the action field 430 of the corresponding entry 410 can additionally or alternatively indicated whether a notification indicating the reassociated DMA memory addresses is to be transmitted to the transaction requestor and/or the transaction target.

In some instances, a faulted transaction 214A can impact one or more subsequent transactions (e.g., transactions 214B-N). Scope field 432 of an entry 410 can indicate whether an action (indicated by the action field 430 of the entry 410) is to be taken with respect to one or more operations 216 of all transactions 214B-N that are subsequent to faulted transaction 214A and/or a particular number of transactions 214B-N that are subsequent to faulted transaction 214A. In some embodiments, scope field 432 can additionally or alternatively indicate whether the action is to be taken with respect to operation(s) 216 of all transactions 214B-N that are subsequent to faulted transaction 214A until a particular match criteria (e.g., indicated by match criteria fields 412 or other match criteria) is satisfied. In an illustrative example, scope field 432 of an entry 410 having particular match criteria 412 can indicate that a particular number subsequent transactions 214B-N to faulted transaction 214A are to be copied to a backup memory buffer (e.g., backup buffer 356A, backup buffer 356B, etc., as described herein). In another illustrative example, an action field 430 of entry 410 can indicate that, for a faulted transaction 214A having particular match criteria 412, a termination action is to be performed with respect to the faulted transaction 214A. The scope field 432 of the entry 410 can further indicate that the termination action is to be performed for each subsequent transaction 214B-N at transaction queue 212 that is subsequent to faulted transaction 214A. In some embodiments, the scope field 432 can further indicate that a notification regarding the terminated subsequent transactions 214B-N is to be transmitted to the transaction requestor and/or the transaction target. In yet another illustrative example, an action field 430 of an entry 410 can indicate that, for a faulted transaction 214A having particular match criteria 412 (e.g., the device is a RDMA networking device, a packet with a packet sequence number (PSN) encountered the page fault, a receiver-not-ready negative acknowledgement (RNR NAK) transaction was sent due to the page fault, and a retransmitted packet with the same PSN was received, etc. ), a termination action is to be performed with respect to the faulted transaction 214A. The scope field 432 can further indicate that the termination action is to be performed for each subsequent transaction 214B-N until a transaction 214 is added to transaction queue 212 that is associated with a packet sequence number that corresponds to the packet sequence number of the faulted transaction 214A.

As illustrated in FIG. 4, fault handling protocol fields 418 can include a recovery field 434. The recovery field 434 of an entry 410 can include an indication of one or more entities that are involved in the recovery or handling of the page fault (e.g., according to the action indicated by action field 430). An entity can be involved in the recovery or handling of a page fault if the entity executes one or more operations associated with a transaction fault handling protocol to address the page fault or if the entity is notified of the page fault and/or initiation or completion of operations associated with the transaction fault handling protocol. For an entry 410 indicating that a rescheduling action is to be taken, the recovery field 434 can indicate that one or more components of device 210 (e.g., transaction handling engine 224, page handling engine 222, etc.) are to execute operations associated with the rescheduling action to handle a faulted transaction 214, in some embodiments. In other or similar embodiments, an entry 410 indicating that a termination action is to be taken can have a recovery field 434 that indicates that one or more components of device 210 and/or the transaction requestor are to execute operations associated with the termination action. For example, an entry 410 having match criteria 412 indicating that a type of device 210 is a RDMA networking device and/or a type of the transaction 214 corresponds to a network packet (e.g., with a PSN) can indicate that a termination action is to be taken in response to a detected page fault. The recovery field 434 of the entry 410 can indicate that upon detecting the page fault, one or more components of the RDMA networking device are to notify the transaction requestor of the page fault (e.g., by transmitting a RNR NAK packet). Each subsequent transaction corresponding to network packets with subsequent PSNs can be dropped (e.g., until the transaction requestor retransmits the packet (e.g., in accordance with one or more protocols of the transaction requestor). The recovery field 430 can additionally or alternatively indicate that if one or more operations of transaction 214A is terminated (e.g., the packet is dropped), the transaction requestor is to initiate a timeout sequence before retransmitting the packet. A length of time that the transaction requestor is to wait before retransmitting the packet can depend on the severity of the transaction fault, in some embodiments. For example, a minor transaction fault can trigger a 10 microsecond delay, while a severe transaction fault can trigger a 1 millisecond delay. In another example, recovery field 434 can indicate that the transaction requestor is to retransmit the packet on another transport level. The RDMA networking device can reinitiate the transaction in accordance with the indication of the recovery field 434.

In some embodiments, an entry 410 indicating that a reassociation action is to be taken can have a recovery field 434 that indicates that one or more entities (e.g., device 210, a transaction requestor, a transaction target, etc.) are to execute operations associated with the reassociation action. For example, the recovery field 434 of an entry 410 having particular match criteria 412 can indicate that one or more components of device 210 are to execute operations associated with a rescheduling action. The recovery field 434 can further indicate that device 210 is to transmit a notification of the rescheduling action to computing system 102 and/or the transaction target, in some embodiments. In another example, the recovery field 434 of an entry 410 having particular match criteria 412 can indicate that one or more components of computing system 102 (e.g., virtualization manager 108) are to execute operations associated with a rescheduling action. The recovery field 434 can further indicate that a connection is to be established between device 210 and one or more components of computing system 102 (e.g., virtualization manager 108, a guest 120, etc.) in order to reschedule the transaction. For example, a rescheduling action can involve copying data from a backup memory location to a memory buffer for a guest (e.g., instead of copying data to a memory location originally indicated by transaction 214). Recovery field 434 can indicate that virtualization manager 108 is to enable the copying from the backup memory location to guest memory space 230, in some embodiments. In yet another example, the recovery field 434 of an entry 410 having particular match criteria 412 can indicate that one or more components (e.g., of device 210, of computing system 102, etc.) associated with a reassociation action is to transmit a notification to the transaction target indicating that data of a transaction 214 is written to an alternative region of memory 106 than the region of memory indicated by transaction 214. In some embodiments, the transaction target can access the data according to the address associated with the alternative region of memory 106. In additional or alternative embodiments, the transaction target may not copy the data to the region of memory that was indicated by transaction 214.

As indicated above, the recovery field 434 of an entry 410 can indicate that device 210 is to execute one or more operations of a fault handling protocol, in some embodiments. In other or similar embodiments, the recovery field 434 of the entry 410 can indicate that another entity (e.g., computing system 102, a transaction requestor, a transaction target, etc.) is to execute one or more operations of the fault handling protocol and/or is to be notified of the execution of the one or more operations. In some embodiments, the entity that is to execute the one or more operations can access fault handling data structure 352, in accordance with embodiments described herein, and can determine which operations of the fault handling protocol to execute in view of the information included in one or more of the fault handling protocol fields 418. In other or similar embodiments, device 210 can transmit a notification and/or one or more instructions to the entity indicating the one or more operations that are to be executed by the entity and/or that execution of the one or more operations has been initiated and/or has completed.

It should be noted that embodiments described with respect to fault handling data structure 352 and/or illustrated in FIG. 4 are provided for purposes of illustration only and are not meant to be limiting. In some embodiments, data of one or more fields and/or entries 410 of fault handling data structure 352 can be distributed across one or more entities (e.g., of system architecture 100 and/or other system architectures). In additional or alternative embodiments, multiple match criteria 412 and/or state criteria can correspond to a single fault handling protocol 418. In yet additional or alternative embodiments, match criteria 412 and/or state criteria can correspond to multiple different state types, where each state type corresponds to a distinct fault handling protocol 418. It should also be noted that information indicated by particular fields of fault handling data structure 352, in accordance with examples provided above, can be included in other fields of fault handling data structure, in some embodiments. For example, information relating to a state of one or more buffers associated with backup and/or alternative DMA memory addresses can be indicated in state criteria field 416 and/or determined in view of information in state lookup field 428 instead of in action field 430.

Referring back to FIG. 3, fault protocol look-up component 306 can select a transaction fault handling protocol to be initiated to address the page fault and corresponding faulted transaction 214A using fault handling data structure 352. In an illustrative example, fault protocol look-up component 306 can identify data associated with device 210, guest 120, transaction 214A and/or transaction 214B-N. The identified data can correspond to characteristic data associated with device 210 and/or guest 120, state data associated with device 210, guest 120, and/or another entity (of system architecture 100 and/or another system architecture), and/or information associated with transaction 214A and/or transaction 214B-N (e.g., as indicated by data of the transaction(s) 214 and/or metadata associated with the transaction(s) 214). The identified data can correspond to one or more match criteria 412 indicated by one or more entries 410 of fault handling data structure 352. In some embodiments, fault protocol look-up component 306 can identify the data by accessing a region of memory 228 (e.g., one or more registers, etc.) that stores the data. In other or similar embodiments, fault protocol look-up component 306 can query virtualization manager 108 or another component of computing system 102 for the data.

In response to identifying the data, fault protocol look-up component 306 can identify an entry 410 of fault handling data structure 352 that includes match criteria 412 and/or state criteria 416 that corresponds to the identified data. In an illustrative example, the identified data can indicate that device 210 is an RDMA networking device. Fault protocol look-up component 306 can identify an entry 410 of data structure 352 that includes match criteria 412 corresponding to a RDMA networking device. In another illustrative example, the identified data can indicate that transaction 214A is a networking packet and that a particular number of networking packets received prior to the packet of transaction 214A have been terminated (e.g., in accordance with a fault handling protocol selected using data structure 352). Fault protocol look-up component 306 can identify an entry 410 of data structure 352 that includes match criteria 412 corresponding to the networking packet and state criteria corresponding to the number of prior networking packets that have been terminated prior to device 210 receiving the networking packet of transaction 214A.

Fault protocol look-up component 306 can determine a fault handling protocol 418 that is to be initiated to address the page fault and corresponding faulted transaction 214A based on the identified entry 410 that includes match criteria 412 and/or state criteria 416 that corresponds to the identified data. For example, in response to identifying entry 410, fault protocol look-up component 306 can determine, from the identified entry 410, an action that is to be taken to address the page fault and corresponding faulted transaction 214A (e.g., from action field 430), a scope of the action that is to be taken (e.g., from scope field 432), and/or one or more entities that are to be involved in recovering from or otherwise handling the page fault (e.g., from recovery field 434). The determined action, scope, and recovery entities can correspond to the fault handling protocol that is to be initiated to address the page fault and the corresponding faulted transaction 214A in some embodiments.

It should be noted that although some embodiments of the present disclosure provide that fault protocol look-up component 306 selects the transaction fault handling protocol to be used to address the page fault and corresponding faulted transaction 214A, fault protocol look-up component 306 can select the transaction fault handling protocol according to other techniques, in additional or alternative embodiments. For example, fault protocol look-up component 306 can provide the identified data associated with device 210, guest 120, transaction 214A and/or transaction 214B-N as input to a function. The function can be configured to provide, as output an indication of a fault handling protocol that is to be initiated in view of the data given as input. In another example, fault protocol look-up component 306 can provide the identified data associated with device 210, guest 120, transaction 214A and/or transaction 214B-N as input to a machine learning model. The machine learning model can be trained to predict, based on given characteristic or state data associated with one or more entities of system architecture 100 and/or data or metadata associated with transactions 214, a fault handling protocol that satisfies one or more performance criteria associated with device 210 and/or system architecture 100. In some embodiments, the machine learning model can be trained using historical and/or experimental data associated with system architecture 100 and/or another system architecture. Fault protocol look-up component 306 can select the transaction fault handling protocol that is to be used to address the page fault and corresponding faulted transaction 214A from one or more outputs of the machine learning model.

In another example, fault protocol lookup component 306 (or another component of transaction handling engine 224) can identify a transaction fault handling protocol based on an engine (e.g., at device 210) that is to handle one or more operations of transaction 214. In an illustrative example, device 210 can include a RX transaction engine configured to handle operations associated with an RX type operation and a TX transaction engine configured to handle operations associated with a TX type operation. Device 210 can issue different interrupts based on whether a page fault is detected during or after execution of the RX type operation (e.g., by the RX transaction engine) or the TX type operation (e.g., by the TX transaction engine). Fault protocol lookup component 306 can determine the transaction fault handling protocol to be implemented based on the interrupted issued by device 210. It should be noted that such example is provided for illustrative purposes only. Fault protocol lookup component 306 can determine a transaction fault handling protocol in view of other criteria associated with the transaction in accordance with and/or in addition to embodiments described herein.

Referring back to FIG. 5, at block 516, processing logic causes the selected transaction fault handling protocol to be performed to address the detected page fault. Faulted transaction handling component 308 can initiate one or more operations associated with the selected transaction fault handling protocol to address the page fault and corresponding faulted transaction 214A, in some embodiments. As indicated above, components of one or more other entities of system architecture 100 can be involved with the transaction fault handling protocol. Faulted transaction recovery component 310 can transmit notifications and/or instructions associated with the protocol to those entities, in some embodiments. For example, as indicated above, the recovery field 434 of an entry of 410 indicating the selected transaction fault handling protocol can indicate that one or more components of computing system 102 (e.g., virtualization manager 108) are to execute one or more operations associated with the selected transaction fault handling protocol. Faulted transaction recovery component 310 can transmit a notification to faulted transaction recovery component 320 of transaction handling engine 242 to cause faulted transaction recovery component 320 to initiate execution of the one or more operations. In another example, the recovery field 434 can indicate that a transaction requestor is to be notified of initiation of one or more operations of the selected transaction fault handling protocol. Faulted transaction recovery component 310 can transmit the notification to the transaction requestor, in some embodiments.

As indicated above, an action of a selected transaction fault handling protocol (e.g., a rescheduling action) can involve requesting that the virtualization manager 108 makes one or more guest memory pages referenced by the faulted transaction 214A (or another transaction 214B-N) available at a region of guest memory space 230 that corresponds to the DMA memory address of the faulted DMA operation 216A. In response to transaction fault handling component 308 selecting such protocol, page request component 302 can transmit a request to virtualization manager 108 to make the guest memory page(s) available. Page request component 318 of page handling engine 240 can receive the request from page request component 302. In response to receiving the request, page request component 318 can identify a storage location associated with the guest memory page and can copy the data of the guest memory page from the identified storage location to guest memory space 230, in some embodiments. In some embodiments, page request component 318 can identify the storage location using a MMU and/or at a data structure managed or otherwise accessible to manager 108, in some embodiments. In response to detecting that data of the guest memory page has been copied to guest memory space 230, page synchronization component 316 can generate a mapping between the DMA memory address of the faulted DMA operation 216A and a physical memory address for the region of memory 106 that stores data of the guest memory page(s). Page synchronization component 316 can update IOMMU 112 to include the mapping, in accordance with previously described embodiments. In response to updating IOMMU 112 to include the mapping, page synchronization component 316 and/or page request component 318 can transmit a notification to page handling engine 222 indicating that the guest memory page(s) is available at guest memory space 230. One or more components of page handling engine 222 and/or transaction handling engine 224 can reschedule execution of the DMA operation 216A of the faulted transaction 214A (or another transaction 214B-N) at device 210 in response to receiving the notification, in some embodiments.

In some instances, virtualization manager 108 (or another component of computing system 102) can cause the guest memory page to be evicted from memory 106 in accordance with a memory page eviction policy, etc. (e.g., if the guest memory page is not pinned to guest memory space 230, as described below). In response to detecting that the guest memory page is evicted from memory 106, page synchronization component 316 can update IOMMU 112 to remove the mapping between the DMA memory address and the physical memory address for the region of 106 that stored the evicted guest memory page and/or can notify page fault detection component 304. Page request component 318 can re-copy data of the guest memory page from the storage location to guest memory page in response to another request to access such data (e.g., in response to another faulted DMA operation 216A at device 210).

The action of the selected transaction fault handling protocol (e.g., the rescheduling action) can additionally or alternatively involve requesting that the virtualization manager 108 pins one or more guest memory pages at guest address space 230. As mentioned above, pinning guest memory pages at guest address space 230 can involve virtualization manager 108 (or another component of computing system 102) updating metadata associated with the guest memory pages to indicate that the data of the guest memory pages is not to be removed from guest address space 230 of memory 106. Guest memory pages that are pinned at the guest address space 230 may not be evicted from memory 106, even if such guest memory pages would be otherwise eligible for eviction in accordance with a memory page eviction policy implemented by computing system 102. The updated metadata can be stored at the IOMMU, the MMU, and/or at a data structure managed or otherwise accessible to virtualization manager 108, in some embodiments. Unpinning guest memory pages can involve virtualization manager 108 (or another component of computing system 102) updating metadata associated with the guest memory pages to indicate that the data of the guest memory pages can be removed from guest address space 230. Such unpinned guest memory pages can therefore be evicted from memory 106, in accordance with the memory page eviction policy.

In response to transaction fault handling component 308 selecting a transaction fault handling protocol that involves guest memory page pinning, page request component 302 can transmit a request to virtualization manager 108 to pin the guest memory page(s) to guest address space 230, in some embodiments. In some embodiments, page request component 302 can transmit the request with a request to make the guest memory page(s) (or other guest memory page(s)) available at guest memory space 230. In other or similar embodiments, page request component 302 can transmit the request prior to or after transmitting the request to make the guest memory page(s) (or the other guest memory page(s)) available at guest memory space 230. In yet other or similar embodiments, page request component 302 can transmit the request to pin the guest memory page(s) without transmitting a request to make the guest memory page(s) available. Page request component 318 of page handling engine 240 can receive the request from page request component 302. In response to receiving the request, page request component 318 can update metadata associated with the guest memory page(s) to indicate that the guest memory page(s) are not to be evicted from memory 106, as described above. Page request component 318 can transmit a notification to page handling engine 222 indicating that the guest memory page(s) are pinned at guest memory space 230. One or more components of page handling engine 222 and/or transaction handling engine 224 can reschedule execution of the DMA operation 216A of the faulted transaction 214A (or another transaction 214B-N) at device 210 in response to receiving the notification, as described above.

In some embodiments, the guest memory page(s) that are pinned at guest memory space 230 can remain pinned until page handling engine 240 receives a request to unpin the guest memory page(s). In other or similar embodiments, the request transmitted to page request component 318 by page request component 302 can indicate one or more conditions associated with pinning the guest memory page(s). For example, the request can indicate that the guest memory page(s) are to be pinned at guest memory space 230 until a threshold amount of time has passed (e.g., after the memory page(s) are initially pinned). In such example, page request component 318 (or another component of page handling engine 240) can unpin the guest memory page(s) in response to detecting that the threshold amount of time has passed. In another example, the request can indicate that he guest memory page(s) are to be pinned at guest memory space 230 until one or more indications are received from device 210, a threshold number of guest memory page(s) are pinned at guest memory space 230, and so forth.

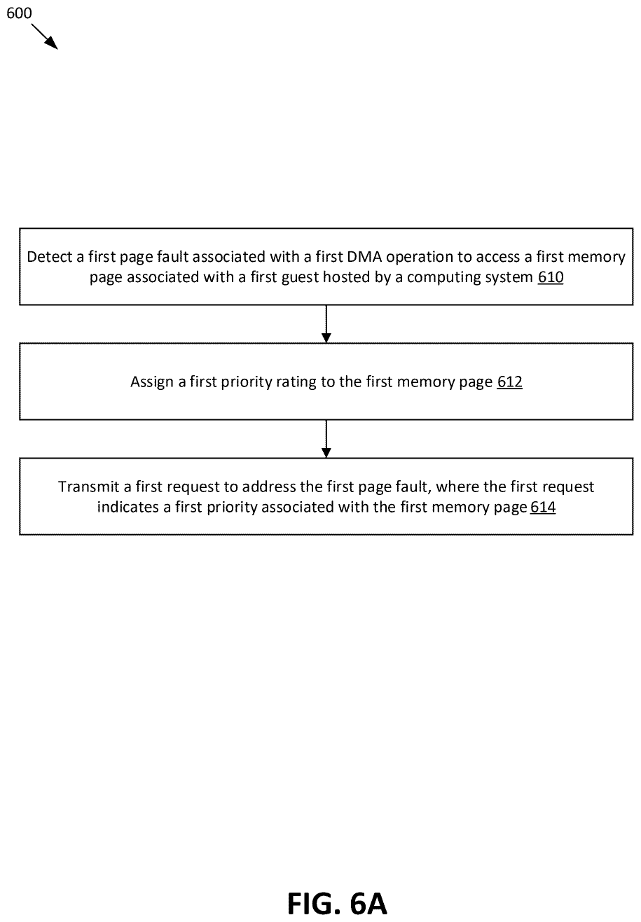

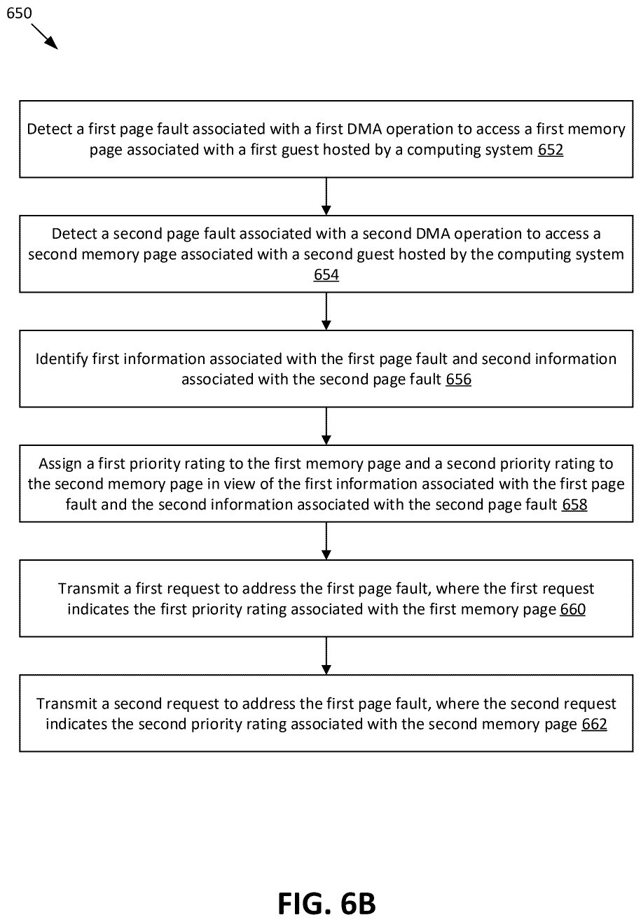

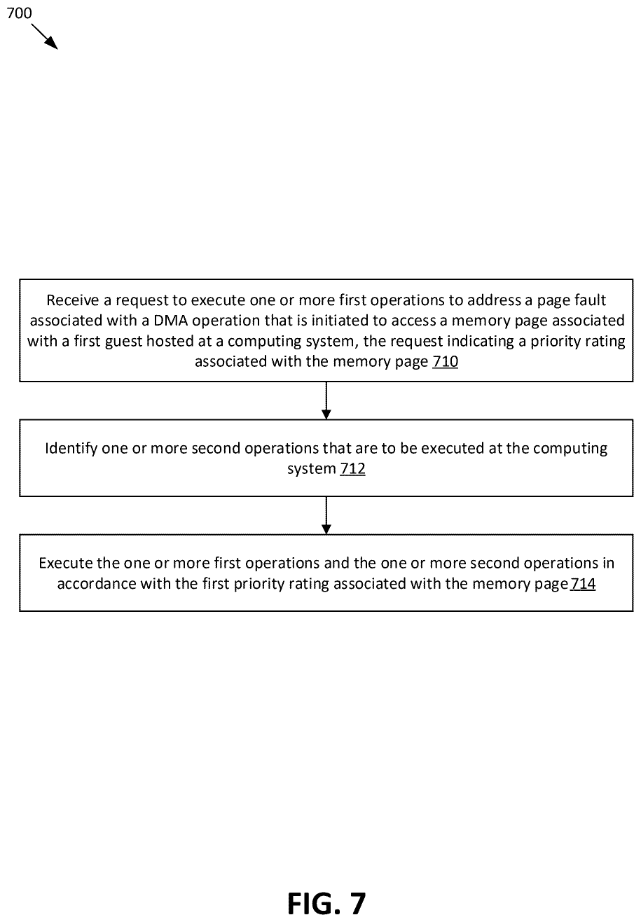

In some embodiments, a request to make a guest memory page available and/or pin the guest memory page at guest memory space 230 can indicate a priority associated with the guest memory page. The priority can indicate to virtualization manager 108 whether to prioritize executing operations associated with the guest memory page over other operations at computing system 102. FIGS. 6A, 6B, and 7 illustrate flow diagrams of example methods 600, 650, 700 relating to priority-based paging requests, in accordance with embodiments of the present disclosure. Methods 600, 650, and/or 700 can be performed by processing logic that can include hardware (circuitry, dedicated logic, etc.), software (e.g., instructions run on a processing device), or a combination thereof. In one implementation, some or all of the operations of methods 600 and/or 650 can be performed by device 210. For example, some or all of the operations of methods 600 and/or 650 can be performed by one or more components of page handling engine 222 and/or transaction handling engine 224 (e.g., residing at device 210), as described herein. In an additional or alternative implementation, some or all of the operations of method 700 can be performed by computing system 102. For example, all or some of the operations of method 700 can be performed by one or more components of page handling engine 240 and/or transaction handling engine 242 (e.g., of virtualization manager 108).

Referring now to FIG. 6A, at block 610, processing logic detects a first page fault associated with a first DMA operation to access a first memory page associated with a first guest hosted by a computing system. The first page fault can be detected by page fault detection component 304, as described above. Fault protocol look-up component 306 can select a transaction fault handling protocol to handle the first page fault (and corresponding faulted transaction 214A), in accordance with previously described embodiments. In some embodiments, an action of the selected transaction fault handling protocol can involve transmitting a request to make the first guest memory page available at guest memory space 230, in accordance with previously described embodiments.

At block 612, processing logic assigns a first priority rating to the first memory page. The first priority rating can indicate to virtualization manager 108 whether to prioritize executing operations associated with the first memory page over other operations associated with other memory pages (e.g., that are associated with other guests 120 hosted by computing system 102 (or another computing system of system architecture 100 or another system architecture). In some embodiments, processing logic can assign the priority rating based on characteristics associated with the device, characteristics associated with the guest, properties of faulted transaction 214A, and/or properties of other transactions 214B-N. As described above, device 210 can be an emulation-capable device that is configured to expose a plurality of emulated devices each having a distinct interface type to computing system 102. Processing logic can assign the priority rating in view of an interface type of an emulated device that corresponds to DMA operation 216A of the faulted transaction 214A or another transaction 214B-N.

At block 614, processing logic transmits a first request to address the first page fault. The first request can correspond to the request transmitted by page request component 302 to make the first memory page available at guest memory space 230 and/or pin the first memory page to guest memory space 230. The first request can indicate the first priority associated with the first memory page. The first request can cause virtualization manager 108 to address the first page fault in accordance with the first priority rating, in accordance with embodiments described with respect to FIG. 7. In an illustrative example, the first request can cause the virtualization manager 108 to execute operations associated with addressing the first page fault prior to executing operations associated with other processes at computing system 102. In another illustrative example, virtualization manager 108 can select a memory page (e.g., IO accessible pages or other memory pages) to swap out of memory 106 (e.g., in accordance with a memory eviction protocol) in view of the first priority associated with the first memory page, in some embodiments. For instance, virtualization manager 108 may select first memory page for eviction in response to determining that the first priority is lower than other priorities for other memory pages at memory 106. In another instance, virtualization manager 108 may select one or more other memory pages for eviction in response to determining that the first priority is higher than other priorities for the other memory pages at memory 106.

As indicated above, in some embodiments, connection 250 can correspond to a PCIe interface (or can be exposed to guest 120 as a PCIe/CXL interface). Page request component 302 can transmit the first request to address the first page fault to virtualization manager 108 by transmitting a signal that indicates information associated with the first request. In some embodiments, one or more portions of the signal can indicate the first priority associated with the first memory page, as described above.

As indicated above, FIG. 6B illustrates a flow diagram of another example method 650 relating to priority-based paging requests, in accordance with embodiments of the present disclosure. At block 652, processing logic detects a first page fault associated with a first DMA operation to access a first memory page associated with a first guest hosted by a computing system. At block 654, processing logic detects a second page fault associated with a second DMA operation to access a second memory page associated with a second guest hosted by the computing system. Processing logic can detect the first page fault and the second page fault in accordance with previously described embodiments. For example, page fault detection component 304 can detect the first page fault in response to an initiation of a first transaction 214A associated with a first guest 120A and the second page fault in response to an initiation for a second transaction 214B associated with a second guest 120B.

At block 656, processing logic identifies first information associated with the first page fault and second information associated with the second page fault. The first information associated with the first page fault can include, but is not limited to, characteristics associated with device 210, characteristics associated with guest 120A, properties of transaction 214A, and/or properties of one or more additional transactions initiated at device 210 (e.g., transaction 214B, transactions 214C-N, etc.). The second information associated with the second page fault can include, but is not limited to, characteristics associated with device 210, characteristics associated with guest 120B, properties of transaction 214B, and/or properties of one or more additional transactions initiated at device 210 (e.g., transaction 214A, transactions 214C-N, etc.). Processing logic can identify the first information and the second information in accordance with previously described embodiments.

At block 658, processing logic assigns a priority rating to the first memory page and a second priority rating to the second memory page in view of the first information associated with the first page fault and the second information associated with the second page fault. At block 660, processing logic transmits a first request to address the first page fault, where the first request indicates the first priority rating associated with the first memory page. At block 662, processing logic transmits a second request to address the second page fault, where the second request indicates the second priority rating associated with the second memory page. In one embodiment, the first priority rating assigned to the first memory page can be higher than the second priority rating assigned to the second memory page. In such embodiments, the first and second requests can cause the virtualization manager 108 to execute operations associated with addressing the first page fault prior to executing operations associated with addressing the second page fault. In another embodiment, the first priority rating assigned to the first memory page can be lower than the second priority rating assigned to the second memory page. In such embodiments, the first and second requests can cause the virtualization manager 108 to execute operations associated with addressing the second page fault prior to executing operations associated with addressing the first page fault. In some embodiments, page request component 302 can transmit the first request and the second request to virtualization manager 108 by transmitting one or more signals that indicate information associated with the first request and/or the second request, as described above. One or more portions of each signal can indicate the first priority associated with the first memory page and/or the second priority associated with the second memory page, as described above.

As indicated above, FIG. 7 illustrates a flow diagram of another example method 700 relating to priority-based paging requests. At block 710, processing logic receives a request to execute one or more first operations to address a page fault associated with a DMA operation that is initiated to access a memory page associated with a first guest hosted at a computing system. As indicated above, the request can be a request transmitted by page request component 302 to make the memory page available at guest memory space 230 and/or pin the memory page to guest memory space 230. The request can indicate a priority rating associated with the memory page. As indicated above, the request can be received by one or more components of virtualization manager 108.

At block 712, processing logic identifies one or more second operations that are to be executed at the computing system. In some embodiments, the one or more second operations can correspond to addressing another page fault associated with another DMA that is initiated (e.g., by device 210 or another device of system architecture 100 or another system architecture) to access another memory page associated with the first guest or one or another guest hosted at the computing system. In other or similar embodiments, the one or more second operations can be associated with other processes associated with other components running at computing system 102. In an illustrative example, the one or more second operations can be operations that are scheduled for execution via processing device(s) 104 by one or more components running at computing system 102.

At block 714, processing logic executes one or more first operations and the one or more second operations in accordance with the first priority rating associated with the memory page. In some embodiments, processing logic (e.g., virtualization manager 108 or another component at computing system 102) can determine the first priority rating associated with the memory page based on the received request. For example, virtualization manager 108 can parse through the signal of the received request and can extract the priority rating for the memory page from the signal. Virtualization manager 108 can associate the extracted priority rating for the memory page with the one or more first operations, in some embodiments.

Virtualization manager 108 can schedule execution of the one or more first operations and the one or more second operations in view of the priority rating for the memory page. In some embodiments, the one or more second operations may not be associated with a priority rating or may be associated with a priority rating that is lower than the priority rating for the memory page. In such embodiments, virtualization manager 108 can schedule the one or more first operations to be executed prior to execution of the one or more second operations (e.g., even if virtualization manager 108 received a request to perform the second operation(s) prior to receiving the request to perform the first operation(s)). In additional or alternative embodiments, at least one of the second operation(s) may be associated with a priority rating that is higher than the priority rating for the memory page. In such embodiments, virtualization manager 108 can schedule the one or more first operations to be performed after the at least one of the second operation(s) but before other operations that are associated with a lower priority rating. The one or more first operations and the one or more second operations can be executed in accordance with the scheduling (e.g., via processing device(s) 104 and/or guest processor(s) 124), in some embodiments.

It should be noted that virtualization manager 108 can associate one or more operations with a particular priority rating without receiving an indication of the priority rating in a request. It an illustrative example, virtualization manager 108 can receive a request from page request component 302 to make a memory page available at guest memory space 230 and/or to pin the memory page to guest memory space 230. The request may not include an indication of a priority rating associated with the memory page, in some embodiments. Virtualization manager 108 can determine whether to assign a priority rating to the memory page and/or to one or more operations associated with the request based on at least one of characteristics associated with device 210, characteristics associated with guest 120, properties of a transaction requested to be initiated at device 210, properties of one or more prior transactions initiated at device 210, and/or properties of one or more operations that are scheduled for execution via processing device(s) 104 and/or guest processor(s) 124. Virtualization manager 108 can assign the priority rating to the memory page and/or the one or more operations associated with the request based on the determination and can schedule the one or more operations for execution according to the assigned priority rating, as described above.

It should be noted that device 210 can transmit requests to virtualization manager 108 (or other components of computing system 102) without initially detecting a page fault. For example, asynchronous request engine 226 can transmit requests to virtualization manager 108 to make data of guest memory page(s) available at guest memory space 230 and/or pin guest memory page(s) at guest memory space 230 asynchronously (e.g., without page handling engine 222 detecting a page fault). As described above, device 210 (or another entity) can add a transaction 214 to transaction queue 212 (e.g., in response to receiving a request to initiate transaction 214 at device 210. In some embodiments, transaction 214 can be added to transaction queue 212 before the transaction 214 is to be initiated. For example, one or more portions of transaction queue 212 can correspond to an RX buffer of a networking device (e.g., a NIC). The transaction 214 associated with one or more networking packets can be added to transaction queue 212 before the networking packets are received by the networking device. Guest memory page identifier component 312 can evaluate data and/or metadata associated with a transaction 214 at transaction queue 212 and can determine whether one or more guest memory pages are to be accessed during execution of operations 216 of the transaction 214.

In response to determining that a guest memory page is to be accessed during execution of operations 216 (e.g., a DMA operation 216A, etc.) of the transaction, guest memory page identifier component 312 can determine whether the guest memory page is available at guest memory space 230. In some embodiments, guest memory page identifier component 312 can determine whether the guest memory page is available at guest memory space 230 by transmitting an inquiry (e.g., via connection 250) to virtualization manager 108. Virtualization manager 108 can determine whether the guest memory page is available at guest memory space 230 using IOMMU 112 and can respond to the inquiry by transmitting a notification to guest memory page identifier component 312 indicating whether the guest memory page is available at guest memory space 230. In additional or alternative embodiments, guest memory page identifier component 312 (or another component of device 210) can manage or can otherwise have access to a data structure (e.g., a list) that includes entries that each correspond to one or more guest memory pages that are available at guest memory space 230 at any given time. In other or similar embodiments, the data structure can include entries that correspond to each guest memory page associated with one or more guests 120, where each entry indicates whether data of the guest memory page is stored at a region of memory 106 or another storage location. Guest memory page identifier component 312 can evaluate one or more entries of the data structure to determine whether the guest memory page is available at guest memory space 230, in some embodiments. In yet additional or alternative embodiments, guest memory page identifier component 312 can determine whether the guest memory page is available at guest memory space 230 according to other techniques.

In response to guest memory page identifier component 312 determining that a guest memory page is not available at guest memory space 230, asynchronous request component 314 can determine whether to transmit an asynchronous request to make the guest memory page available at guest memory space 230 and/or to pin the guest memory page at guest memory space 230. In some embodiments, asynchronous request component 314 can determine whether to transmit the asynchronous request based on at least one of characteristics of the device 210, characteristics of guest 120, properties of transaction 214 that includes the operation 216 to access the guest memory page, and/or properties of other transactions 214 at transaction queue 212. In other or similar embodiments, asynchronous request component 314 can determine whether to transmit the asynchronous request according to other techniques. In an illustrative example, asynchronous request component 314 can determine to transmit the asynchronous request in response to determining that device 210 is a networking device and a page fault caused by an attempt to access the guest memory page at guest memory space 230 can significantly impact latency and throughput of system architecture 100. In another illustrative example, asynchronous request component 314 can determine to transmit the asynchronous request in response to determining that the guest memory page is to be accessed during execution of operations 216 associated with multiple transactions 214.

Asynchronous request component 314 can transmit the asynchronous request to virtualization manager 108 (or another component of computing system 102), as described above. In some embodiments, asynchronous request component 314 can transmit the asynchronous request in response to guest memory page identifier component 312 determining that the guest memory page is not available at guest memory space 230. In other or similar embodiments, asynchronous request component 314 can transmit the asynchronous request in response to receiving a request to register a DMA buffer at device 210. In some embodiments, the asynchronous request can include an indication of a priority rating associated with the guest memory page, as described above. Virtualization manger 108 (or the other component of computing system 102) can perform operations associated with the request, in accordance with embodiments described above. If the asynchronous request includes an indication of the priority rating associated with the guest memory page, virtualization manager 108 can schedule operations associated with the request to be executed in accordance with the indicated priority rating, in some embodiments.

As indicated above, the asynchronous request can be a request to pin a guest memory page at guest memory space 230, in some embodiments. Asynchronous request component 314 can, in some embodiments, transmit an additional asynchronous request to unpin the guest memory page from guest memory space 230. For example, guest memory page identifier component 312 and/or asynchronous request component 314 can determine that the guest memory page is to be pinned at guest memory space 230 for a particular amount of time and/or until a particular number of transactions 214 have been completed. In response to determining that the particular amount of time has passed and/or the particular number of transactions 214 have been completed, asynchronous request component 314 can transmit the additional asynchronous request to unpin the guest memory page from guest memory space 230. Virtualization manager 108 (or another component of computing system 102) can update metadata associated with the guest memory page (e.g., at IOMMU 112) to indicate that the guest memory page can be removed from guest memory space 230 (e.g., in accordance with a memory page eviction protocol). In another example, asynchronous request component 314 can transmit the additional asynchronous request in response to receiving a request to deregister the DMA buffer at device 210.

In other or similar embodiments, asynchronous request component 314 can transmit information associated with unpinning the guest memory page from guest memory space 230 with the request to pin the guest memory page. For example, asynchronous request component 314 can include, with the request to pin the guest memory page at guest memory space 230, instructions or information indicating that the guest memory page is to be unpinned from guest memory space 230 after a threshold amount of time has passed (e.g., from receipt of the request, from pinning the memory page, etc.). After detecting that the threshold amount of time has passed (e.g., from receiving the request, from pinning the memory page, etc.), virtualization manager 108 can update metadata associated with the guest memory page to indicate that the guest memory page can be removed from the guest memory space 230 (e.g., without receiving an additional asynchronous request from device 210).

In some embodiments, virtualization manager 108 can limit the number of asynchronous requests that can be transmitted by devices 210. For example, to reduce the number of devices 210 (and/or guests 120) that are pinning guest memory pages to guest address space 230, virtualization manager 108 can limit the number of asynchronous pinning requests that can be transmitted by devices 210. Once a device 210 transmits a number of asynchronous pinning requests that satisfies the limit, virtualization manager 108 can ignore (e.g., drop) subsequent asynchronous pinning requests from the device 210, in some embodiments. In other or similar embodiments, device 210 can transmit a notification to device 210 indicating that the limit of asynchronous pinning requests allocated to the device 210 has been reached. Asynchronous request component 314 can transmit one or more requests to unpin guest memory pages and pin alternative or additional guest memory pages at guest memory space 230, in response to receiving the notification, in some embodiments. In other or similar embodiments, asynchronous request component 314 can delay transmission of asynchronous pinning requests in response to receiving the notification (e.g., until the threshold amount of time associated with prior asynchronous pinning requests has passed, etc.). In yet other or similar embodiments, virtualization manager 108 can transmit a notification of the limit of asynchronous pinning requests that are allocated to the device 210 (e.g., during an initialization of the device 210). In response to detecting that the limit has been reached, asynchronous request component 314 can delay transmission of the asynchronous pinning requests, as described above.

In an illustrative example, a transaction 214 can include one or more DMA operations 216A to access metadata associated with other operations of the transaction 214 and/or operations 216 of another transaction 214. For instance, operations 216 of a transaction 214 can involve accessing metadata associated with a network packet received from a transaction requestor and/or to be transmitted to a transaction requestor. The accessed metadata can correspond to a work request or a completion request associated with the network packet. Asynchronous request component 214 and/or page request component 302 can transmit requests to pin memory pages associated with the work request or the completion request at guest memory space 230, as described above. In some embodiments, asynchronous request component 214 and/or page request component 302 can maintain one or more data structures which include an indication of one or more guest memory pages that correspond to such metadata. Asynchronous request component 214 and/or page request component 302 can access the data structure to determine which guest memory pages correspond to such metadata and can issue a single pinning request to pin such guest memory pages at guest memory space 230, in some embodiments.

As illustrated in FIG. 3, memory 228 can include at least one transaction execution buffer 354 and/or one or more backup buffers 356. A transaction execution buffer 254 can be configured to store data associated with one or more operations 216 (e.g., DMA operations 216A, non-DMA operations 216B, etc.) that are executed for a transaction 214 initiated at device 210. In an illustrative example, one or more components of device 210 (e.g., components of page handling engine 222, components of transaction handling engine 224, etc.) can copy data to a region of transaction execution buffer 354 (e.g., in response to detecting that transaction 214 is initiated at device 210). One or more of processor(s) 220 (of device 210) or processing device(s) 104 (of computing system 102) can access the data copied to transaction execution buffer 354 prior to or during execution of operations 216, in some embodiments. In some embodiments, transaction execution buffer 354 can be managed by the transaction requestor, the transaction target, device 210, and/or one or more components of computing system 102 (e.g., virtualization manager 108, etc.).

As described above, page fault detection component 304 can detect a page fault during execution of operations 216 (e.g., during execution of a DMA operation 216A, etc.) and fault protocol look-up component 306 can select a transaction fault handling protocol to handle the page fault and corresponding faulted transaction 214A. As indicated above, one or more transaction fault handling protocols can involve using one or more backup memory buffers 356. For example, as indicated above, a reassociation action can involve determining one or more other guest memory pages that are associated with other DMA memory addresses and writing data of an operation 216A that caused a page fault to the other guest memory page(s) via one or more DMA memory operations 216A. The DMA memory addresses for the other guest memory page(s) can be associated with a backup memory buffer. In another example, data associated with a transaction 214 that is being rescheduled (e.g., in accordance with a rescheduling action of a selected transaction fault handling protocol) can be temporarily stored at one or more of backup memory buffer 356. In some embodiments, the data can be stored at backup memory buffer(s) 356 until device 210 detects that data of a guest memory page is available at guest memory space 230 and/or pinned at guest memory space 230. It should be noted that backup memory buffers 356 can be used or otherwise accessed while implementing other transaction fault handling protocols, in some embodiments.

In some embodiments, each backup memory buffer 356 (also referred to herein as simply backup buffer 356) can be managed by the transaction requestor, the transaction target, device 210, and/or one or more components of computing system 102 (e.g., virtualization manager 108, etc.). In some embodiments, backup buffer(s) 356 can be global backup buffers that are allocated to store data (or metadata) associated with each guest 120 hosted by computing system 102. In other or similar embodiments, one or more backup buffers 356 can be allocated to store data and/or metadata associated with a particular guest 120 hosted by computing system 102. For example, a first backup buffer 356A can be allocated to store data and/or metadata associated with guest 120A and a second backup buffer 356B can be allocated to store data and/or metadata associated with guest 120B. Such configuration of backup buffers 356 can provide data isolation between guests 120, in some embodiments. For example, as one or more backup buffers 356 are allocated to particular guests 120, such guests 120 are not able to consume all of the buffer space available at memory 230 (e.g., buffer space that is allocated to other guests 120). In yet other or similar embodiments, each backup buffer 356 can be allocated to store data and/or metadata associated with transactions 214 at a particular transaction queue 212. For example, device 210 can maintain multiple transaction queues 212, as described above. A first backup buffer 356A can be allocated to store data and/or metadata associated with a first transaction queue 212 and a second backup buffer 254B can be allocated to store data and/or metadata associated with a second transaction queue 212. Such configuration of backup buffers 356 can provide data isolation between transaction queues 212, in some embodiments.

It should be noted that although backup buffers 356 are illustrated in FIG. 3 as part of memory 230, one or more of backup buffers 356 can reside at other locations of system architecture 100. For example, one or more of backup buffers 356 can reside at a portion of memory 106 that is allocated to virtualization manager 108. In another example, one or more of backup buffers 356 can reside at guest memory space 230. In yet another example, one or more of backup buffers 356 can reside at peer guest memory space.

In some embodiments, backup memory buffer(s) 356 can include one or more ring buffers (also referred to as a circular buffer, a circular queue, a cyclic buffer, etc.). Backup memory buffer(s) 356 can include any other type of buffer, in accordance with embodiments of the present disclosure. Backup buffer(s) 356 can include a contiguous virtual and/or physical memory space, in some embodiments. In additional or alternative embodiments, backup buffer(s) 356 can include other types of memory space. A buffer context (e.g., maintained or otherwise accessible by device 210) can define a type of buffer that is to be used to store data and can indicate one or more buffer descriptors for the buffer, in some embodiments. In other or similar embodiments, the buffer context can include an indication of a data structure (e.g., a work queue, a link list, a flat database, etc.) that indicates one or more buffer descriptors for the buffer.

Backup buffer(s) 356 can include one or more entries that are configured to store data, as described herein. Each entry can correspond to one or more buffer descriptors. The buffer context can further define how each entry is to be consumed to store data. For example, the buffer context can indicate that each entry is to be consumed by data of a single transaction 214 (e.g., corresponding to a packet), is to be consumed by data of multiple transactions 214 (e.g., multiple packets), and so forth. For example, data for each packet received by the device 210 can consume a single buffer entry. In another example, data for each packet can consume multiple buffer entries. In yet another example, data for multiple packets can consume a single buffer entry. In yet another example, data for a packet can partially consume a buffer entry. Since the buffer entry is partially consumed, a consecutive packet can consume the same buffer starting from the last byte of the previous packet or from a byte rounded up to an offset (e.g., a stride) indicated by the buffer context.

As indicated above, backup buffer(s) 356 can include one or more ring buffers. In such embodiments, data stored at backup buffer(s) 356 can be accessed in accordance with the order to which the data was added to backup buffer(s) 356. In some embodiments, metadata associated with the data stored at backup buffer(s) 356 can include an indication of an order to which the data was added to backup buffer(s) 356. A head register and/or a tail register for each buffer entry can indicate which data at backup buffer(s) 356 are valid. In additional or alternative embodiments, backup buffer(s) 356 can include one or more link lists, as indicated above. In such embodiments, one or more components of device 210 (e.g., components of page handling engine 222, components of transaction handling engine 224, etc.) can add data to backup buffer(s) 356 as a link list. Accordingly, metadata for data at backup buffer(s) 356 may not include an indication of an ordering associated with the data, in some embodiments. In some embodiments, a head register and/or a tail register for each buffer entry can indicate which data at backup buffer(s) 356 are valid, as described above. In other or similar embodiments, a head register and/or a tail register for the last element of the link list can indicate which data at backup buffer(s) 356 are valid. In yet additional or alternative embodiments, backup buffer(s) 356 can include a flat database, as indicated above. In such embodiments, metadata for data stored at backup buffer(s) 356 can include a bitmap that indicates which data at backup buffer(s) 356 are valid.

In some embodiments, one or more components of device 210 and/or one or more components of computing system 102 can maintain a data structure (e.g., a database, etc.) that indicates an availability of backup buffer(s) 356. A component of device 210 and/or a component of computing system 102 can access the data structure to determine an availability of backup buffer(s) 356, in some embodiments. In an illustrative example, the data structure can reside at memory 106 of computing system 102. The data structure can include an indication of a pointer for a location of available backup buffer(s) 356. The pointers can be added to the data structure by one or more components of computing system 102 (e.g., virtualization manager 108) and/or one or more components of device 210. In another illustrative example, the data structure can reside at memory 228 of device 210. The data structure can be exposed (e.g., to guest 120) as a memory mapped input/output (MMIO) accessible register space on device 210, in some embodiments.

As described above, transaction queue 212 can include multiple transactions 214. In some embodiments, each transaction 214 at transaction queue 212 can be associated with an ordering condition. For example, two or more transactions 214 can be associated with a common transaction target and/or a common transaction requestor. In such example, metadata associated with the two or more transactions 214 can indicate an ordering associated with execution of operations of the transactions 214. The ordering can be designated by or can be otherwise specific to the transaction requestor and/or the transaction target, in some embodiments. In other or similar embodiments, the ordering can be determined in view of one or more transaction protocols of device 210. For example, a transaction protocol of device 210 can provide that transactions 214 are to be initiated in accordance with an order at which requests to initiate the transactions 214 are received. In another example, the transaction protocol of device 210 can provide that transactions 214 requested by particular transaction requestors are to be initiated prior to initiating transactions requested by other transaction requestors. In other or similar embodiments, one or more transactions 214 at transaction queue 212 may not be associated with an ordering condition. In such embodiments, the transactions 214 can be initiated in accordance with any ordering or in accordance with a default ordering for device 210.

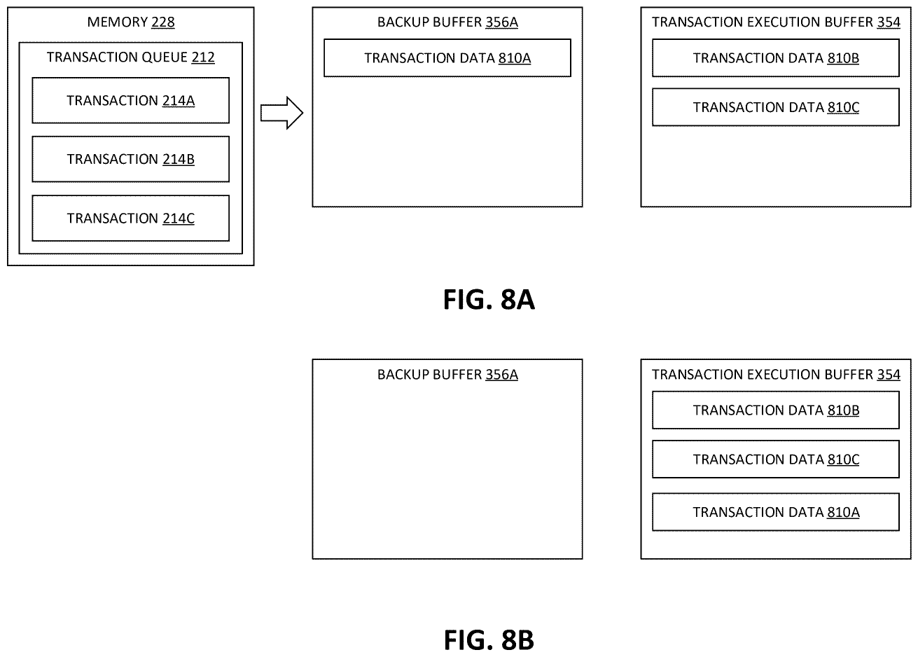

In accordance with embodiments described above, one or more of transactions 214 at transaction queue 212 can be faulted transactions 214A. Data associated with faulted transactions 214A and/or non-faulted transactions 214B-N can be stored at one or more of transaction execution buffer 354 and/or backup buffer(s) 356, depending on an ordering condition (or lack of ordering condition) for transactions 214 at transaction queue 212. FIGS. 8A-8B illustrate an example of completion handling for one or more faulted transactions 214A at device 210, in accordance with implementations of the present disclosure. As illustrated in FIG. 8A, transaction queue 212 can include one or more transactions 214, as described above. Transactions 214 at transaction queue 212 may not be associated with an ordering condition, in some embodiments. Page request component 302 can execute operations 216 of transactions 214, as described above. In an illustrative example, page fault detection component 304 can detect a page fault associated with execution of a DMA operation 216A of transaction 214A, as described herein. In response to page fault detection component 304 detecting the page fault, fault protocol look-up component 306 can select a transaction fault handling protocol, in accordance with embodiments described herein. Page fault detection component 304 (or another component of page handling engine 222 and/or transaction handling engine 224) can store data associated with DMA operation 216A of transaction 214A at backup buffer 356A (and/or backup buffer 356B), in accordance with previously described embodiments. As illustrated in FIG. 8A, data associated with DMA operation 216A of transaction 214A can be stored at an entry of backup buffer 365A (e.g., depicted as transaction data 810A).

As transactions 214 at transaction queue 212 are not associated with an ordering condition, page request component 302 can execute operations 216 of transactions 214B and 214C before the page fault of transaction 214A is handled (e.g., in accordance with the selected transaction fault handling protocol). In some embodiments, page fault detection component 302 may not detect a page fault during execution of operations 216 of transactions 214B and 214C. Accordingly, transactions 214B and 214C are completed successfully at device 210 (e.g., data of guest memory pages referenced by operations 216 of transactions 214B and 214C is accessed at guest memory space 230). Page request component 302 (or another component of page handling engine 222 and/or transaction handling engine 224) can store data associated with operations 216 of transactions 214B and 214C at transaction execution buffer 354, in accordance with previously described embodiments. As illustrated in FIG. 8A, data associated with operations 216 of transaction 214B and 214C can be stored at one or more entries of transaction execution buffer 354 (e.g., depicted as transaction data 810B and transaction data 810C, respectively).

In some embodiments, faulted transaction handling component 308 (or another component of page handling engine 222 and/or transaction handling engine 224) can detect that the guest memory page that caused the page fault for DMA operation 216A of faulted transaction 214A is available and/or pinned at guest memory space 230. In response to detecting that the guest memory page is available and/or pinned at guest memory space 230, page request component 302 (or another component of page handling engine 222 and/or transaction handling engine 224) can execute the DMA operation 216A of faulted transaction 214A to handle the transaction fault (e.g., in accordance with the selected transaction fault handling protocol). Page request component 302 can store data associated with operations 216 of transaction 214A at transaction execution buffer 354. As illustrated in FIG. 8B, data associated with operations 216 (including the faulted DMA operation 216A) of transaction 214A can be stored at one or more entries of transaction execution buffer 354. It should be noted that the ordering to which transaction data 810A, 810B, and 810C is added to entries of transaction execution buffer 354 is for purposes of illustration only. Transaction data 810A, 810B, and/or 810C can be added to entries of transaction execution buffer 354 in accordance to other orderings, in other or similar embodiments.

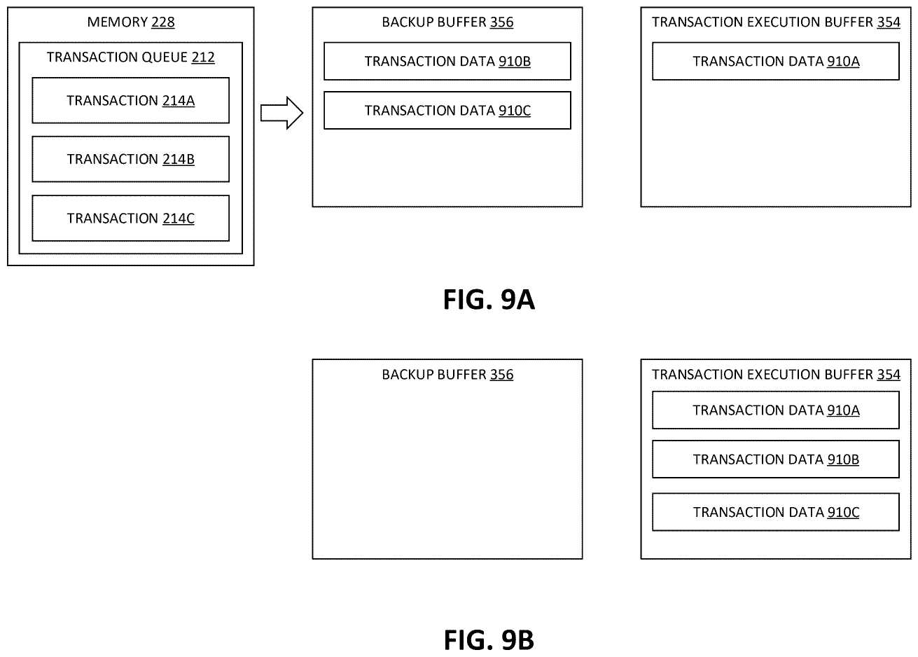

FIGS. 9A-9B illustrate another example of completion handling for one or more faulted transactions 214A at device 210, in accordance with implementations of the present disclosure. As illustrated in FIG. 8A, transaction queue 212 can include one or more transactions 214, as described above. Transactions 214 at transaction queue 212 may be associated with an ordering condition, in some embodiments. For example, device 210 may be associated with a transaction protocol that provides that transactions 214 are to be initiated according to an order to which requests for transactions 214 are received. In another example, transactions 214 may be associated with an ordering condition in view of a common transaction requestor and/or transaction target associated with transactions 214, as described above.

Page request component 302 can execute operations 216 of transaction 214A, as described above. In some embodiments, page fault detection component 304 may not detect a page fault during execution of operations 216 and transaction fault 214A can be successfully completed. Page request component 302 (or another component of page handling engine 222 and/or transaction handling engine 224) can store data associated with operations 216 of transaction 214A at transaction execution buffer 354, as previously described. As illustrated in FIG. 9A, data associated with operations 216 of transaction 214A can be stored at one or more entries of transaction execution buffer 354 (e.g., depicted as transaction data 910A).

Page request component 302 can execute operations 216 of transaction 214B, as described above. Page fault detection component 304 can detect a page fault during execution of operations 216 of transaction 214B and fault protocol look-up component 306 can select a transaction fault handling protocol, in accordance with previously described embodiments. Page request component 302 (or another component of page handling engine 222 and/or transaction handling engine 224) can store data associated with operations 216 of transaction 214B at backup buffer 356 until the page fault of operations 216 is handled (e.g., in accordance with the selected transaction fault handling protocol). As illustrated in FIG. 9A, data associated with operations 216 of transaction 214B can be stored at one or more entries of backup buffer(s) 356 (e.g., depicted as transaction data 910B). Page request component 302 (or another component of page handling engine 222 and/or transaction handling engine 224) can determine, based on the ordering condition of transactions 214 at transaction queue 212, that transaction 214C cannot be initiated until transaction 214B is completed. Accordingly, page request component 302 can store data associated with operations 216 of transaction 214C at backup buffer 356. As illustrated in FIG. 9B, data associated with operations 216 of transaction 214C can be stored at one or more entries of backup buffer(s) 356 (e.g., depicted as transaction data 910C).

In some embodiments, faulted transaction handling component 308 (or another component of page handling engine 222 and/or transaction handling engine 224) can detect that the guest memory page that caused the page fault for faulted transaction 214B is available and/or pinned at guest memory space 230. In response to detecting that the guest memory page is available and/or pinned at guest memory space 230, page request component 302 (or another component of page handling engine 222 and/or transaction handling engine 224) can execute operations 216 of faulted transaction 214B to handle the transaction fault (e.g., in accordance with the selected transaction fault handling protocol). Page request component 302 can store data associated with operations 216 of transaction 214B at transaction execution buffer 354. As illustrated in FIG. 9B, data associated with operations 216 of transaction 214B can be stored at one or more entries of transaction execution buffer 354. In response to detecting that transaction 214B is complete, page request component 302 can initiate operations 216 of transaction 214C. Page request component 302 can store data associated with operations 216 of transaction 214C at transaction execution buffer 354 (e.g., so long as page fault detection component 302 does not detect a page fault). Page request component 302 (or another component of device 210 and/or computing system 102) can wait to transmit metadata associated with transaction 214C (e.g., transaction completion metadata, etc.) to the transaction requestor and/or the transaction target until transaction 214B (and transaction 214C) are successfully completed, in some embodiments. As illustrated in FIG. 9B, data associated with operations 216 of transaction 214B can be stored at one or more entries of transaction execution buffer 354. It should be noted that the ordering to which transaction data 910A, 910B, and 910C is added to entries of transaction execution buffer 354 is for purposes of illustration only. Transaction data 910A, 910B, and/or 910C can be added to entries of transaction execution buffer 354 in accordance to other orderings, in other or similar embodiments.

In some embodiments, data for transactions 214 at transaction execution buffer 354 can become out of order from an initial ordering at transaction queue 212 (e.g., in response to an ordering at which the data is stored at backup buffer(s) 356). In some embodiments, metadata associated with transaction data 810, 910 can include an indication of the initial ordering of transactions 214 at transaction queue 212. For example, the metadata for each entry of transaction execution buffer 354 can include an indication of an ordering associated with the corresponding transaction 214 at transaction queue 212. One or more components running at device 210 (e.g., a buffer manager component (not shown), a component of page handling engine 222 and/or transaction handling engine 224, etc.) can rearrange transaction data 810, 910 at transaction execution buffer 354 to correspond to the ordering indicated by the metadata, in some embodiments.

In some embodiments, one or more components of device 210 can transmit a notification to entities of system architecture 100 (e.g., a transaction requestor, a transaction target, etc.) indicating a status of data associated with a transaction 214 at device 210. For example, one or more components of device 210 can transmit a notification to a transaction target indicating that data associated with a faulted transaction 214A is currently stored at one or more of backup buffer(s) 356). Once the data is moved to transaction execution buffer 354, the one or more components can transmit another notification to the transaction target indicating that the data is currently stored at transaction execution buffer 354. In yet another example, one or more components of device 210 can maintain a data structure that includes entries corresponding to transactions 214 of transaction queue 212. Each entry can include an indication of a storage location (e.g., transaction execution buffer 354, backup buffer 356, etc.) that currently stores data associated with a transaction 214 at transaction queue 212. Entities of system architecture 100 can access the data structure to determine a status of data associated with a transaction 212, in some embodiments.

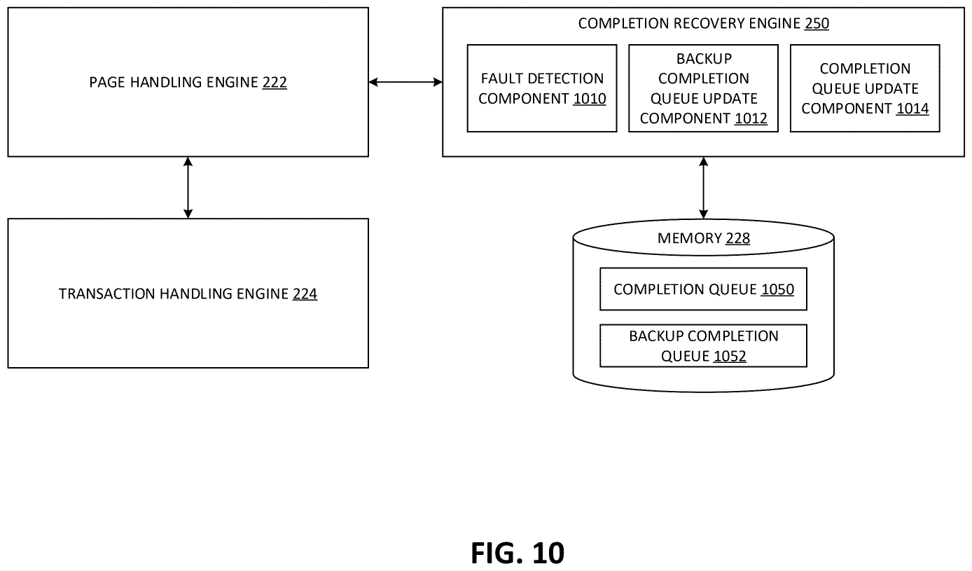

Device 210 can include a completion recovery engine 254 (e.g., as illustrated in FIG. 2). Completion recovery engine 254 can be configured to manage completion queues at device 210, in some embodiments. FIG. 10 depicts an example completion recovery engine 254, in accordance with implementations of the present disclosure. As illustrated in FIG. 10, completion recovery engine 254 can include a fault detection component 1010, a backup completion queue update component 1012, and/or a completion queue update component 1014, in some embodiments. As further illustrated in FIG. 10, memory 228 of device 210 can include a completion queue 1050 and/or a backup completion queue 1052. A completion queue refers to a queue that indicates completion events for transactions (e.g., transactions 214 at transaction queue 212 that have completed). In some embodiments, completion queue 1050 can indicate completion events for transactions 214 that have successfully completed (e.g., operations 216 of the transaction 214 have executed without a page fault and/or after a page fault has been handled, as described above). Backup completion queue 1052 can indicate completion events for transactions 214 that have been paused or otherwise delayed from completion due to a page fault caused by one or more operations 216. Once the page fault of a faulted transaction 214A is handled (e.g., in accordance with previously described embodiments) and the transaction 214 is successfully completed, the indication of a completion event for transaction 214 can be removed from backup completion queue 1052 and added to completion queue 1050. One or more components of device 210 and/or computing system 102 can transmit a notification to a transaction requestor and/or a transaction target indicating the completion of transactions 214 indicated by completion queue 1050, in some embodiments. In other or similar embodiments, the transaction requestor and/or the transaction target can access completion queue 1050 and/or backup completion queue 1052 to determine a status of a transaction 214.

It should be noted that although FIG. 10 depicts completion queue 1050 and backup completion queue 1052 residing at memory 228, completion queue 1050 and/or backup completion queue 1052 can reside at other memory locations of system architecture 100. For example, completion queue 1050 and/or backup completion queue 1052 can reside at memory 106 of computing system 102. In another example, completion queue 1050 and/or backup completion queue 1052 can reside at memory 228 of device 210 and can be accessible to one or more components of computing system 102.

In some embodiments, an indication of a faulted transaction 214A can be added to backup completion queue 1052 after data associated with operations 216 of faulted transaction 214A are stored at backup buffer(s) 356. As described above, data associated with operations 216 of a faulted transaction 214A can be added to backup completion queue 1052 even though a page fault has not been detected for the operations 216. For example, data associated with transaction 214C can be added to an entry of backup buffer(s) 356 in response to a page fault detected for transaction 214A and/or 214B, as described above with respect to FIGS. 9A-9B.

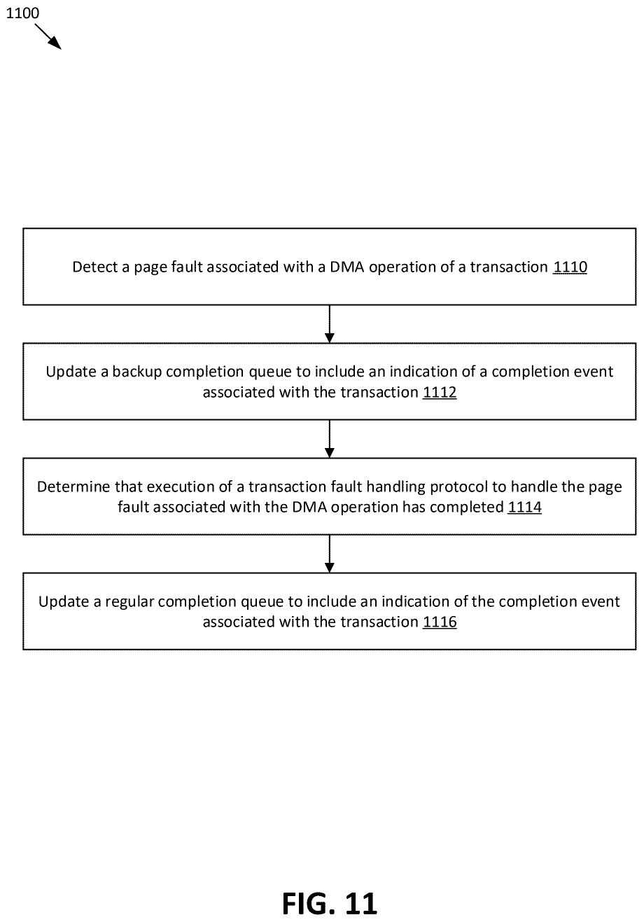

FIG. 11 illustrates a flow diagram of an example method 1100 for completion synchronization, according to at least one embodiment. Method 1100 can be performed by processing logic that can include hardware (circuitry, dedicated logic, etc.), software (e.g., instructions run on a processing device), or a combination thereof. In one implementation, some or all of the operations of method 1100 can be performed by device 210. For example, some or all of the operations of method 1100 can be performed by one or more components of completion recovery engine 254 (e.g., residing at device 210), as described herein.

At block 1100, processing logic detects a page fault associated with a DMA operation of a transaction. The DMA operation can be executed to access a guest memory page associated with a guest of one or more guests hosted by computing system 102, in some embodiments. Fault detection component 1010 can detect the page fault in response to page request component 302 initiating execution of a DMA operation 216A of a transaction 214, as described above.

At block 1112, processing logic can update a backup completion queue to include an indication of a completion event associated with the transaction. Backup completion queue update component 1012 can update backup completion queue 1052 to include an indication of a completion event associated with transaction 214, in some embodiments. In some embodiments, backup completion queue update component 1012 can update backup completion queue 1052 in response to determining that a backup completion queue criterion is satisfied. Backup completion queue update component 1012 can determine that the backup completion queue criterion is satisfied by determining that the page fault (e.g., detected in accordance with operations of block 1110) has not yet been handled, in some embodiments. In additional or alternative embodiments, backup completion queue update component 1012 can determine that the backup completion queue criterion is satisfied if completions have not yet been fully synchronized between completion queue 1050 and backup completion queue 1052, in accordance with embodiments described herein. In response to determining that the backup completion queue criterion is not satisfied, backup completion queue update component 1012 (or another component of completion recovery engine 250, such as completion queue update component 1014) can update completion queue 1050 to include an indication of the completion event.

Backup completion queue update component 1012 can update backup completion queue 1052 by adding (e.g., posting) the completion event to the backup completion queue 1052 and/or by updating a consumer index. Backup completion queue component 1012 can add the completion event to the backup completion queue 1052 by updating metadata associated with the completion event to indicate the backup completion queue 1052, in some embodiments. In other or similar embodiments, component 1012 can add the completion event to the backup completion queue 1052 by writing the completion event to the backup completion queue 1052. In some embodiments, backup completion queue update component 1012 can transmit a signal to one or more of page handling engine 222 and/or transaction handling engine 224 to cause transaction handling engine to select a transaction fault handling protocol, as described above. Transaction handling engine 224 can select the transaction fault handling protocol and can initiate one or more operations of the transaction fault handling protocol to handle the page fault, in accordance with previously described embodiments. In some embodiments, backup completion queue update component 1012 can transmit a signal for each completion event at backup completion queue 1052 or a signal for multiple completion events at backup completion queue 1052.

At block 1114, processing logic determines that execution of a transaction fault handling protocol to handle the page fault associated with the DMA operation has completed. Completion of execution of the transaction fault handling protocol can indicate that the page fault of the DMA operation has been handled and the transaction is therefore successfully completed. Processing logic (e.g., backup completion queue update component 1012 and/or completion queue update component 1014) can determine that the execution of the transaction fault handling protocol selected by transaction handling engine 224 is complete by detecting at least one of an interrupt, polling on a consumer index, or polling on the backup completion queue 1052 and/or completion queue 1050 from page handling engine 222 and/or transaction handling engine 224.

At block 1116, processing logic (e.g., completion queue update component 1014) updates a regular completion queue (e.g., completion queue 1050) to include an indication of the completion event associated with the transaction. In some embodiments, completion queue update component 1014 updates the regular completion queue by updating metadata associated with the completion event to indicate (or otherwise correspond to) the regular completion queue, updating the producer index, or transmitting a command to initiate a synchronization protocol, as described herein. Completion queue update component 1014 can remove the indication of the completion event form backup completion queue 1052, in some embodiments.

It should be noted that embodiments described with respect to FIG. 11 are provided for example and explanation only and are not to be interpreted as limiting. For example, embodiments and examples described with respect to FIG. 11 can be applied for any type of event at which selection of a completion queue is needed and/or synchronization operations are to be executed. These can include events that do not involve a page fault.

As indicated above, data associated with operations 216 of transactions 214 can be added to backup completion queue 1052 even though a page fault has not been detected for operations. In such embodiments, backup completion queue update component 1012 can update backup completion queue 1052 to include additional indications of additional completion events associated with such transactions 214. Such transaction is delayed due to the page fault associated with the DMA operation 216A of the faulted transaction 214A. Backup completion queue update component 1012 can continue to update backup completion queue 1052 to include the additional indications of additional completion events until completion queue update component 1014 (or another component of completion recovery engine 254) determines that execution of the transaction fault handling protocol to handle the page fault associated with the DMA operation has completed. In response to detecting that the execution of the transaction fault handling protocol is completed, completion queue update component 1014 can initiate a synchronization protocol to transfer the one or more additional indications of the additional completion events from backup completion queue 1052 to completion queue 1050. The synchronization protocol can involve completion queue update component 1014 copying the indications of the additional completion events from backup completion queue 1052 to completion queue 1050 and removing the indications from backup completion queue 1052. Once the synchronization protocol is completed, processing logic can resume posting completion events to completion queue 1050.

In some embodiments, backup completion queue update component 1012 can stall updating backup completion queue 1052 until the synchronization protocol is completed. Backup completion queue update component 1012 can stall updating backup completion queue 1052 until a threshold number of completions are synchronized with completion queue 1050, in some embodiments. In additional or alternative embodiments, backup completion queue update component can stall updating backup completion queue 1052 until a threshold amount of time has passed (e.g., since the synchronization protocol was initiated).

As indicated above, processor(s) 220 can be a programmable extension of one or more components or modules of computing system 102, in some embodiments. In such embodiments, processor(s) 220 can be used as a mediation between a transaction target (e.g., guest 120) and one or more components (e.g., hardware components) of device 210. For example, processor(s) 220 can be used as mediation between the transaction target and one or more hardware components of device 210, which exposes emulated devices to computing system 102, as described above. In some embodiments, one or more engines running on processor(s) 220 (e.g., completion recovery engine 254) can detect that a transaction 214 has successfully completed at device 210 after a page fault for the transaction 214 has been handled, as described above. Completion recovery engine 254 can transmit a notification of the completion to the transaction target. As processor(s) 220 are a programmable extension of computing system 102, processor(s) 220 can serve as an intermediate transaction target, in some embodiments. In such embodiments, the transaction target (e.g., guest 120) may not be aware of the page fault that caused the faulted transaction 214A, although components running on processor(s) 220 (e.g., the intermediate transaction target) may be aware. In an illustrative example, device 210 can maintain a single queue that is configured to store indications of completion events for successfully completed transactions (e.g., completion events of completion queue 1050) and completion events for faulted transactions 214A and/or transactions that have otherwise been delayed by faulted transactions 214A (e.g., completion events of backup completion queue 1052). In such embodiments, completion recovery engine 254 can copy data from the queue to a target completion queue residing at or otherwise accessible to the transaction target, in some embodiments. Completion recovery engine 254 (or another component or engine at device 210) can copy data associated with the transactions 214 from transaction execution buffer 354 and/or backup buffer(s) 356 to a target buffer residing at or otherwise accessible to the transaction target.

As indicated above, transactions 214 can include one or more DMA operations 216A to write data to one or more regions of guest memory space 230. For example, a transaction 214 can include one or more DMA operations 216A to write data from network device RX packets, data from a block device IO read, and so forth. In some embodiments, instead of writing the data directly to guest memory pages at guest memory space 230, device 210 can initially write to a staging buffer (not shown). The staging buffer can reside at device 210 (e.g., at memory 228) or at computing system 102 (e.g., at memory 106), in some embodiments. In such embodiments, device 210 can update completion queue 1050 and/or backup completion queue 1052 to include an indication of a completion event associated with writing data of the transaction 214 to the staging buffer. The completion event can include an indication of the original DMA memory address associated with the data of transaction 214 and an indication of the location of the staging buffer that stores the data. In some embodiments, device 210 can copy the data from the staging buffer to a buffer of the transaction target. If a page fault for the guest memory page associated with the original DMA memory address is detected, device 210 can select a fault transaction handling protocol to be initiated to address the page fault, as described above. In an illustrative example, the selected fault transaction handling protocol can involve rescheduling the copy operation to copy the data from the staging buffer to the transaction target buffer at a later time period.

As described above, device 210 can be a RDMA networking device, in some embodiments. In some embodiments, device 210 can detect a page fault, as described above, and can transmit to the transaction requestor a RNR NAK packet. Data for the RNR NAK packet can include an indication of a timer, in some embodiments. Device 210 can set the timer to correspond to an expected page fault handling time. The timer can correspond to an amount of time that the transaction requestor should wait before retransmitting the RNR NAK packet to device 210. In one example, device 210 can set the timer to correspond to the severity of a detected page fault (e.g., based on an amount of time that passed to handle previous page faults, etc.). In another example, device 210 can set the timer to correspond to a default amount of time associated with handing a page fault. If device 210 detects that an amount of retransmissions received from the transaction requestor within the amount of time set by the timer meets or exceeds a threshold, device 210 can increase the amount of time of the timer accordingly.

In additional or alternative embodiments, a transaction 214 at a transaction queue 212 of a RDMA networking device can correspond to a packet for a wired local area network (e.g., Ethernet, etc.). The transaction target can encapsulate data associated with network traffic (e.g., in an RDMA request or any other RNR-supporting protocol) and include the data with the packet transmitted to device 210, in some embodiments. Device 210 can deliver the data associated with the network traffic to the transaction target as an Ethernet packet, in some embodiments. If a page fault is detected during initiation of the transaction 214, device 210 can transmit a RNR NAK packet to the transaction requestor, which in turn can retransmit the request to initiate the transaction 214, as described above.

FIG. 12 illustrates a block diagram illustrating an exemplary computer device 1200, in accordance with implementations of the present disclosure. Computer device 1200 can correspond to one or more components of computing system 102 and/or one or more components of device 210, as described above. Example computer device 1200 can be connected to other computer devices in a LAN, an intranet, an extranet, and/or the Internet. Computer device 1200 can operate in the capacity of a server in a client-server network environment. Computer device 1200 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 1200 can include a processing device 1202 (also referred to as a processor, CPU, or GPU), a main memory 1204 (e.g., read-only memory (ROM), flash memory, dynamic random access memory (DRAM) such as synchronous DRAM (SDRAM), etc.), a static memory 1206 (e.g., flash memory, static random access memory (SRAM), etc.), and a secondary memory (e.g., a data storage device 1018), which can communicate with each other via a bus 1230.

Processing device 1202 (which can include processing logic 1203) represents one or more general-purpose processing devices such as a microprocessor, central processing unit, or the like. More particularly, processing device 1202 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1202 can also be one or more special-purpose processing devices such as an ASIC, a FPGA, a digital signal processor (DSP), network processor, or the like. In accordance with one or more aspects of the present disclosure, processing device 1202 can be configured to execute instructions performing method 500 for handling page faults at a fault resilient transaction handling device, methods 600, 650, and/or 700 for priority-based paging requests, and/or method 1100 for completion synchronization.

Example computer device 1200 can further comprise a network interface device 1208, which can be communicatively coupled to a network 1220. Example computer device 1200 can further comprise a video display 1210 (e.g., a liquid crystal display (LCD), a touch screen, or a cathode ray tube (CRT)), an alphanumeric input device 1212 (e.g., a keyboard), a cursor control device 1214 (e.g., a mouse), and an acoustic signal generation device 1216 (e.g., a speaker).

Data storage device 1218 can include a computer-readable storage medium (or, more specifically, a non-transitory computer-readable storage medium) 1228 on which is stored one or more sets of executable instructions 1222. In accordance with one or more aspects of the present disclosure, executable instructions 1222 can comprise executable instructions performing method 500 for handling page faults at a fault resilient transaction handling device, methods 600, 650, and/or 700 for priority-based paging requests, and/or method 1100 for completion synchronization.

Executable instructions 1222 can also reside, completely or at least partially, within main memory 1204 and/or within processing device 1202 during execution thereof by example computer device 1200, main memory 1204 and processing device 1202 also constituting computer-readable storage media. Executable instructions 1222 can further be transmitted or received over a network via network interface device 1208.

While the computer-readable storage medium 1228 is shown in FIG. 12 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

In at least one embodiment, in an effort to preserve patient confidentiality (e.g., where patient data or records are to be used off-premises), computer device 1200 may include or may be otherwise connected to a cloud. The cloud may include a registry—such as a deep learning container registry. In at least one embodiment, a registry may store containers for instantiations of applications that may perform pre-processing, post-processing, or other processing tasks on patient data. In at least one embodiment, cloud may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

Other computer system designs and configuration may be suitable to implement the systems and methods described herein. The following examples illustrate various implementations in accordance with one or more aspects of the present disclosure.
Example 1, is a method comprising: receiving, at a device connected to a computing system that hosts a guest, a request to initiate a transaction involving a direct memory access (DMA) operation to access data associated with at the guest; detecting a page fault associated with execution of the DMA operation of the transaction; selecting, from a plurality of transaction fault handling protocols, a transaction fault handling protocol that is to be initiated to address the detected page fault; and causing the selected transaction fault handling protocol to be performed to address the detected page fault.
Example 2 is a method of Example 1, wherein the transaction fault handling protocol is selected based on at least one of: characteristics associated with the device; characteristics associated with the guest; properties of the transaction requested to be initiated; or properties of one or more prior transactions initiated at the device.
Example 3 is a method of Example 2, wherein at least one of the transaction or the one or more prior transactions correspond to one or more of: a communication flow-type transaction; a queue-type transaction; or a sub-device type transaction.
Example 4 is a method of Example 1, wherein the device is an emulation-capable device that is configured to expose a plurality of emulated devices each having a distinct interface type to the computing system, and wherein the transaction fault handling protocol is selected from the plurality of transaction fault handling protocols based on an interface type of an emulated device corresponding to the transaction.
Example 5 is a method of Example 1, wherein the selected transaction fault handling protocol involves one or more of: rescheduling at least one operation of the transaction, wherein the at least one operation comprises the DMA operation or another operation of the transaction; terminating the at least one operation of the transaction; or updating a memory address associated with at least one of the one or more DMA operations of the transaction to correspond to another memory address.
Example 6 is a method of Example 1, wherein selecting the fault handling protocol that is to be initiated to address the detected page fault comprises: accessing a transaction fault handling data structure that comprises the plurality of transaction fault handling protocols, wherein each of the plurality of transaction fault handling protocols is associated with characteristics associated with the guest, properties of the transaction requested to be initiated, or properties of one or more prior transactions initiated at the device; identifying an entry of the transaction fault handling data structure that corresponds to at least one of characteristics associated with the guest hosted by the computing system, properties of the transaction requested to be initiated, or properties of one or more prior transactions initiated at the device; and determining the transaction fault handling protocol based on the identified entry.
Example 7 is a method of Example 1, wherein causing the selected transaction fault handling protocol to be performed comprises: transmitting, to a virtualization manager associated with the computing system, one or more of a first request to pin a particular region of memory of the computing system or a second request to make one or more memory pages associated with the data available at the particular region of the memory of the computing system.
Example 8 is a method of Example 7, wherein the second request to make the one or more memory pages associated with the data available at the particular region of the memory of the computing system comprises an indication of a priority associated with each of the one or more memory pages associated with the data, and wherein the second request is to cause the virtualization manager to, responsive to receiving the second request, configure the one or more memory pages at the particular region of the memory in accordance with the indicated priority associated with each of the one or more memory pages.
Example 9 is a method of Example 1, further comprising: identifying a memory buffer residing on at least one of the device or a memory associated with the computing system, wherein the identified memory buffer is allocated for at least one of the one or more guests, the device, or the transaction; and storing the data associated with the one or more DMA operations at the identified memory buffer.
Example 10 is a method of Example 9, wherein the identified memory buffer is included in a set of memory buffers that is managed by: the guest hosted by the computing system; a virtualization manager associated with the guest; or a controller associated with the device.
Example 11 is a method of Example 1, further comprising: determining one or more additional memory pages to be referenced in the transaction or one or more subsequent transactions requested for initiation at the device; and transmitting one or more of a first request to pin a particular region of memory of the computing system to accommodate the one or more additional memory pages or a second request to make the one or more additional memory pages available at the particular region of the memory of the computing system.
Example 12 is a method of Example 1, wherein each of the guest corresponds to a virtual machine or a container.
Example 13 is a method of Example 1, wherein the device is connected to the computing system via a system bus, wherein the system bus corresponds to at least one of a peripheral component interconnect express (PCIe) interface, a commute express link (CXL) interface, a die-to-die (D2D) interconnect interface, a chip-to-chip (C2C) interconnect interface, a graphics processing unit (GPU) interconnect interface, or a coherent accelerator processor interface (CAPI).
Example 14 is a system comprising: a memory; and a device, coupled to the memory and a computing system that hosts a guest, to perform operations comprising: receiving a request to initiate a transaction involving a direct memory access (DMA) operation to access data associated with the guest; detecting a page fault associated with execution of the DMA operation of the transaction; selecting, from a plurality of transaction fault handling protocols, a transaction fault handling protocol that is to be initiated to address the detected page fault; and causing the selected transaction fault handling protocol to be performed to address the detected page fault.
Example 15 is a system of Example 14, wherein the transaction fault handling protocol is selected based on at least one of: characteristics associated with the device; characteristics associated with the guest; properties of the transaction requested to be initiated; or properties of one or more prior transactions initiated at the device.
Example 16 is a system of Example 15, wherein at least one of the transaction or the one or more prior transactions correspond to one or more of: a communication flow-type transaction; a queue-type transaction; or a sub-device type transaction.
Example 17 is a system of Example 14, wherein the device is an emulation-capable device that is configured to expose a plurality of emulated devices each having a distinct interface type to the computing system, and wherein the transaction fault handling protocol is selected from the plurality of transaction fault handling protocols based on an interface time of an emulated device corresponding to the transaction.
Example 18 is a systems of Example 14, wherein the selected transaction fault handling protocol involves one or more of: rescheduling at least one operation of the transaction, wherein the at least one operation comprises the DMA operation or another operation of the transaction; terminating the at least one operation of the transaction; or updating a memory address associated with at least one of the one or more DMA operations of the transaction to correspond to another memory address.
Example 19 is a system of Example 14, wherein selecting the fault handling protocol that is to be initiated to address the detected page fault comprises: accessing a transaction fault handling data structure that comprises the plurality of transaction fault handling protocols, wherein each of the plurality of transaction fault handling protocols is associated with characteristics associated with the guest, properties of the transaction requested to be initiated, or properties of one or more prior transactions initiated at the device; identifying an entry of the transaction fault handling data structure that corresponds to at least one of characteristics associated with the guest hosted by the computing system, properties of the transaction requested to be initiated, or properties of one or more prior transactions initiated at the device; and determining the transaction fault handling protocol based on the identified entry.
Example 20 is a non-transitory computer-readable medium storing instructions thereon, wherein the instructions, when executed by a processing device of a computing system that hosts a guest, cause the processing device to perform operations comprising: receiving a request to initiate a transaction involving a direct memory access (DMA) operation to access data associated with at least one of the guest; detecting a page fault associated with execution of the DMA operation of the transaction; selecting, from a plurality of transaction fault handling protocols, a transaction fault handling protocol that is to be initiated to address the detected page fault; and causing the selected transaction fault handling protocol to be performed to address the detected page fault.
Example 21 is a method comprising: detecting, at a device connected to a computing system that hosts one or more guests, a first page fault associated with a first DMA operation to access a first memory page associated with a first guest of the one or more guests; and transmitting, to a virtualization manager of the computing system, a first request to address the first page fault, wherein the first request indicates a first priority rating associated with the first memory page, and wherein the first request is to cause the virtualization manager to, responsive to receiving the first request, address the first page fault in accordance with the first priority rating associated with the first memory page.
Example 22 is a method of Example 21, wherein the first request to address the first page fault comprises at least one of: a request to pin the first memory page to a particular region of memory of the computing system; or a request to make the first memory page available at the particular region of the memory of the computing system.
Example 23 is a method of Example 21, further comprising: determining the priority rating associated with the first memory page based on at least one of: characteristics associated with the device; characteristics associated with the guest; properties of a transaction associated with the first DMA operation; or properties of one or more additional transactions initiated at the device.
Example 24 is a method of Example 21, wherein the device is an emulation-capable device that is configured to expose a plurality of emulated devices each having a distinct interface type to the computing system, and wherein the first priority rating associated with the first memory page corresponds to an interface type of an emulated device corresponding to the first DMA operation.
Example 25 is a method of Example 21, further comprising: detecting a second page fault associated with a second DMA operation to access a second memory page associated with a second guest of the one or more guests; identifying first information associated with the first page fault and second information associated with the second page fault; and assigning the first priority rating to the first memory page in view of the first information associated with the first page fault and the second information associated with the second page fault.
Example 26 is a method of Example 25, further comprising: assigning a second priority rating to the second memory page in view of the first information associated with the first page fault and the second information associated with the second page fault, wherein the second priority rating is lower than the first priority rating assigned to the first memory page; and transmitting, to the virtualization manager of the computing system, a second request to address the second page fault, wherein the second request indicates the second priority rating associated with the second memory page, and wherein the second request is to cause the virtualization manager to, responsive to receiving the second request, address the first page fault associated with the first memory page prior to addressing the second page fault associated with the second memory page.
Example 27 is a method of Example 25, further comprising: assigning a second priority rating to the second memory page in view of the first information associated with the first page fault and the second information associated with the second page fault, wherein the second priority rating is higher than the first priority rating assigned to the first memory page; and transmitting, to the virtualization manager of the computing system, a second request to address the second page fault, wherein the second request indicates the second priority rating associated with the second memory page, and wherein the second request is to cause the virtualization manager to, responsive to receiving the second request, address the first page fault associated with the first memory page after addressing the second page fault associated with the second memory page.
Example 28 is a system comprising: a memory; and a processing device coupled to the memory, wherein the processing device is to perform operations comprising: receiving, from a device, a request to execute one or more first operations to address a page fault associated with a DMA operation that is initiated to access a memory page associated with a first guest hosted at a computing system, wherein the request indicates a priority rating associated with the memory page; identifying one or more second operations that are to be executed at the computing system; and executing the one or more first operations and the one or more second operations in accordance with the first priority rating associated with the memory page.
Example 29 is a system of Example 28, wherein at least one of the one or more second operations correspond to an additional page fault associated with an additional DMA operation to access an additional memory page associated with at least one of the first guest or a second guest hosted at the computing system.
Example 30 is a system of Example 28, wherein executing the one or more first operations and the one or more second operations in accordance with the first priority rating associated with the memory page comprises: determining whether the first priority rating associated with the memory page is higher than second priority ratings associated with the one or more second operations; and responsive to determining that the first priority rating is higher than the second priority ratings, scheduling the one or more first operations to be executed prior to execution of the one or more second operations.
Example 31 is a system of Example 30, further comprising: responsive to determining that first priority rating is not higher than the second priority ratings, scheduling the one or more second operations to be executed prior to execution of the one or more first operations.
Example 32 is a system of Example 28, wherein the received request comprises at least one of: a request to pin the memory page to a particular region of memory of the computing system; or a request to make the memory page available at the particular region of the memory of the computing system.
Example 33 is a system of Example 28, wherein the first guest corresponds to a virtual machine or a container.
Example 34 is a non-transitory computer-readable medium storing instructions thereon, wherein the instructions, when executed by a processing device of a computing system that hosts one or more guests, cause the processing device to: detecting, at a device connected to a computing system that hosts one or more guests, a first page fault associated with a first DMA operation to access a first memory page associated with a first guest of the one or more guests; and transmitting, to a virtualization manager of the computing system, a first request to address the first page fault, wherein the first request indicates a first priority rating associated with the first memory page, and wherein the first request is to cause the virtualization manager to, responsive to receiving the first request, address the first page fault in accordance with the first priority rating associated with the first memory page.
Example 35 is a non-transitory computer-readable medium of Example 34, wherein the first request to address the first page fault comprises at least one of: a request to pin the first memory page to a particular region of memory of the computing system; or a request to make the first memory page available at the particular region of the memory of the computing system.
Example 36 is a non-transitory computer-readable medium of Example 34, wherein the operations further comprise: determining the priority rating associated with the first memory page based on at least one of: characteristics associated with the device; characteristics associated with the guest; properties of a transaction associated with the first DMA operation; or properties of one or more additional transactions initiated at the device.
Example 37 is a non-transitory computer-readable medium of Example 34, wherein the device is an emulation-capable device that is configured to expose a plurality of emulated devices each having a distinct interface type to the computing system, and wherein the first priority rating associated with the first memory page corresponds to an interface type of an emulated device corresponding to the first DMA operation.
Example 38 is a non-transitory computer-readable medium of Example 34, wherein the operations further comprise: detecting a second page fault associated with a second DMA operation to access an second memory page associated with a second guest of the one or more guests; identifying first information associated with the first page fault and second information associated with the second page fault; and assigning the first priority rating to the first memory page in view of the first information associated with the first page fault and the second information associated with the second page fault.
Example 39 is a non-transitory computer-readable medium of Example 38, wherein the operations further comprise: assigning a second priority rating to the second memory page in view of the first information associated with the first page fault and the second information associated with the second page fault, wherein the second priority rating is lower than the first priority rating assigned to the memory page; and transmitting, to the virtualization manager of the computing system, a second request to address the second page fault, wherein the second request indicates the second priority rating associated with the second memory page, and wherein the second request is to cause the virtualization manager to, responsive to receiving the second request, address the first page fault associated with the first memory page prior to addressing the second page fault associated with the second memory page.
Example 40 is a non-transitory computer-readable medium of Example 38, wherein the operations further comprise: assigning a second priority rating to the second memory page in view of the first information associated with the first page fault and the second information associated with the second page fault, wherein the second priority rating is higher than the first priority rating assigned to the first memory page; and transmitting, to the virtualization manager of the computing system, a second request to address the second page fault, wherein the second request indicates the second priority rating associated with the second memory page, and wherein the second request is to cause the virtualization manager to, responsive to receiving the second request, address the first page fault associated with the first memory page after addressing the second page fault associated with the second memory page.
Example 41 is a method comprising: detecting, at a device connected to a computing system that hosts one or more guests, a page fault associated with a DMA operation of a transaction, wherein the DMA operation is executed to access a memory page associated with a guest of the one or more guests; updating a backup completion queue to include an indication of a completion event associated with the transaction; determining that execution of a transaction fault handling protocol to handle the page fault associated with the DMA operation has completed; and updating a regular completion queue to include an indication of the completion event associated with the transaction.
Example 42 is a method of Example 41, wherein the backup completion queue is configured to store indications of completion events associated with faulted transactions and the regular completion queue is configured to store indications of completion events associated with successfully completed transactions.
Example 43 is a method of Example 41, further comprising: updating the backup completion queue to include one or more additional indications of additional completion events associated with additional transactions that are delayed due to the page fault associated with the DMA operation of the transaction.
Example 44 is a method of Example 43, further comprising: responsive to updating the backup completion queue to include the indication of the completion event associated with the transaction, initiating a synchronization protocol to transfer the one or more additional indications of the additional completion events associated with the additional transactions from the backup completion queue to the regular completion queue.
Example 45 is a method of Example 41, wherein updating the regular completion queue to include the indication of the completion event associated with the transaction comprises at least one of: updating metadata associated with the completion event to indicate the regular completion queue; writing the completion event to the regular completion queue to indicate the completion event; updating a producer index; or transmitting a command to initiate a synchronization protocol.
Example 46 is a method of Example 41, wherein determining that execution of a transaction fault handling protocol to handle the page fault associated with the DMA operation has completed comprises detecting at least one of: an interrupt; polling on a consumer index; or polling on the backup completion queue or the regular completion queue.
Example 47 is a method of Example 41, further comprising: removing the indication of the completion event from the backup completion queue.
Example 48 is a system comprising: a memory; and a device coupled to the memory, wherein the device is to perform operations comprising: detecting a page fault associated with a DMA operation of a transaction, wherein the DMA operation is executed to access a memory page associated with a guest of one or more guests hosted by a computing system; updating a backup completion queue to include an indication of a completion event associated with the transaction; determining that execution of a transaction fault handling protocol to handle the page fault associated with the DMA operation has completed; and updating a regular completion queue to include an indication of the completion event associated with the transaction.
Example 49 is a system of Example 48, wherein the backup completion queue is configured to store indications of completion events associated with faulted transactions and the regular completion queue is configured to store indications of completion events associated with successfully completed transactions.
Example 50 is a system of Example 48, wherein the operations further comprise: updating the backup completion queue to include one or more additional indications of additional completion events associated with additional transactions that are delayed due to the page fault associated with the DMA operation of the transaction.
Example 51 is a system of Example 50, responsive to updating the backup completion queue to include the indication of the completion event associated with the transaction, initiating a synchronization protocol to transfer the one or more additional indications of the additional completion events associated with the additional transactions from the backup completion queue to the regular completion queue.
Example 52 is a system of Example 48, wherein updating the regular completion queue to include the indication of the completion event associated with the transaction comprises at least one of: updating metadata associated with the completion event to indicate the regular completion queue; updating a producer index; or transmitting a command to initiate a synchronization protocol.
Example 53 is a system of Example 48, wherein determining that execution of a transaction fault handling protocol to handle the page fault associated with the DMA operation has completed comprises detecting at least one of: an interrupt; polling on a consumer index; or polling on the backup completion queue or the regular completion queue.
Example 54 is a non-transitory computer-readable medium storing instructions thereon, wherein the instructions, when executed by a processing device of a computing system that hosts one or more guests, cause the processing device to perform operations comprising: detecting a page fault associated with a DMA operation of a transaction, wherein the DMA operation is executed to access a memory page associated with a guest of one or more guests hosted by a computing system; updating a backup completion queue to include an indication of a completion event associated with the transaction; determining that execution of a transaction fault handling protocol to handle the page fault associated with the DMA operation has completed; and updating a regular completion queue to include an indication of the completion event associated with the transaction.
Example 55 is a non-transitory computer-readable medium of Example 54, wherein the backup completion queue is configured to store indications of completion events associated with faulted transactions and the regular completion queue is configured to store indications of completion events associated with successfully completed transactions.
Example 56 is a non-transitory computer-readable medium of Example 54, wherein the operations further comprise: updating the backup completion queue to include one or more additional indications of additional completion events associated with additional transactions that are delayed due to the page fault associated with the DMA operation of the transaction.
Example 57 is a non-transitory computer-readable medium of Example 56, wherein the operations further comprise: responsive to updating the backup completion queue to include the indication of the completion event associated with the transaction, initiating a synchronization protocol to transfer the one or more additional indications of the additional completion events associated with the additional transactions from the backup completion queue to the regular completion queue.
Example 58 is a non-transitory computer-readable medium of Example 54, wherein updating the regular completion queue to include the indication of the completion event associated with the transaction comprises at least one of: updating metadata associated with the completion event to indicate the regular completion queue; updating a producer index; or transmitting a command to initiate a synchronization protocol.
Example 59 is a non-transitory computer-readable medium of Example 54, wherein determining that execution of a transaction fault handling protocol to handle the page fault associated with the DMA operation has completed comprises detecting at least one of: an interrupt; polling on a consumer index; or polling on the backup completion queue or the regular completion queue.
Example 60 is a non-transitory computer-readable medium of Example 54, wherein the operations further comprise: removing the indication of the completion event from the backup completion queue.
Example 61 is a system of Example 28, wherein the operations further comprise: determining that the first priority rating associated with the memory page is higher than second priority ratings associated with other memory pages; and evicting the other memory pages associated with the second priority ratings from a region of the memory based on the determination.
Example 62 is a method of Example 40, further comprising: determining whether to include the indication of the completion event associated with the transaction at the backup completion queue or at the regular completion queue in view of an availability of the backup completion queue.
Example 63 is a system of Example 48, wherein the operations further comprise: determining whether to include the indication of the completion event associated with the transaction at the backup completion queue or at the regular completion queue in view of an availability of the backup completion queue.
Example 64 is a non-transitory computer-readable medium of Example 54, wherein the operations further comprise: determining whether to include the indication of the completion event associated with the transaction at the backup completion queue or at the regular completion queue in view of an availability of the backup completion queue.
Example 65 is a method of Example 11, further comprising: transmitting a third request to unpin the particular region of memory of the computing system.
Example 66 is a method of Example 41, further comprising: determining whether to include the indication of the completion event associated with the transaction at the backup completion queue or at the regular completion queue in view of a synchronization completion status.

What is claimed is:

1. A method comprising:
receiving, at a device connected to a computing system that hosts one or more guests, a request to initiate a transaction involving a direct memory access (DMA) operation to access data associated with at least one of the one or more guests;
detecting a page fault associated with execution of the DMA operation of the transaction;
selecting, from a plurality of transaction fault handling protocols, a transaction fault handling protocol that is to be initiated to address the detected page fault; and
causing the selected transaction fault handling protocol to be performed to address the detected page fault.

2. The method of claim 1, wherein the transaction fault handling protocol is selected based on at least one of:
characteristics associated with the device;
characteristics associated with the one or more guests;
properties of the transaction requested to be initiated; or
properties of one or more prior transactions initiated at the device.

3. The method of claim 2, wherein at least one of the transaction or the one or more prior transactions correspond to one or more of:
a communication flow-type transaction;
a queue-type transaction; or
a sub-device type transaction.

4. The method of claim 1, wherein the device is an emulation-capable device that is configured to expose a plurality of emulated devices each having a distinct interface type to the computing system, and wherein the transaction fault handling protocol is selected from the plurality of transaction fault handling protocols based on an interface type of an emulated device corresponding to the transaction.

5. The method of claim 1, wherein the selected transaction fault handling protocol involves one or more of:
rescheduling at least one operation of the transaction, wherein the at least one operation comprises the DMA operation or another operation of the transaction;
terminating the at least one operation of the transaction; or
updating a memory address associated with at least one of the one or more DMA operations of the transaction to correspond to another memory address.

6. The method of claim 1, wherein selecting the fault handling protocol that is to be initiated to address the detected page fault comprises:
accessing a transaction fault handling data structure that comprises the plurality of transaction fault handling protocols, wherein each of the plurality of transaction fault handling protocols is associated with characteristics associated with the one or more guests, properties of the transaction requested to be initiated, or properties of one or more prior transactions initiated at the device;
identifying an entry of the transaction fault handling data structure that corresponds to at least one of characteristics associated with the one or more guests hosted by the computing system, properties of the transaction requested to be initiated, or properties of one or more prior transactions initiated at the device; and
determining the transaction fault handling protocol based on the identified entry.

7. The method of claim 1, wherein causing the selected transaction fault handling protocol to be performed comprises:
transmitting, to a virtualization manager associated with the computing system, one or more of a first request to pin a particular region of memory of the computing system or a second request to make one or more memory pages associated with the data available at the particular region of the memory of the computing system.

8. The method of claim 7, wherein the second request to make the one or more memory pages associated with the data available at the particular region of the memory of the computing system comprises an indication of a priority associated with each of the one or more memory pages associated with the data, and wherein the second request is to cause the virtualization manager to, responsive to receiving the second request, configure the one or more memory pages at the particular region of the memory in accordance with the indicated priority associated with each of the one or more memory pages.

9. The method of claim 1, further comprising:
identifying a memory buffer residing on at least one of the device or a memory associated with the computing system, wherein the identified memory buffer is allocated for at least one of the one or more guests, the device, or the transaction; and
storing the data associated with the one or more DMA operations at the identified memory buffer.

10. The method of claim 9, wherein the identified memory buffer is included in a set of memory buffers that is managed by:
at least one guest of the one or more guests hosted by the computing system;
a virtualization manager associated with the one or more guests; or
a controller associated with the device.

11. The method of claim 1, further comprising:
determining one or more additional memory pages to be referenced in the transaction or one or more subsequent transactions requested for initiation at the device; and
transmitting one or more of a first request to pin a particular region of memory of the computing system to accommodate the one or more additional memory pages or a second request to make the one or more additional memory pages available at the particular region of the memory of the computing system.

12. The method of claim 11, further comprising:
transmitting a third request to unpin the particular region of memory of the computing system.

13. The method of claim 1, wherein the guest corresponds to a virtual machine, a container, or a process.

14. The method of claim 1, wherein the device is connected to the computing system via a system bus, wherein the system bus corresponds to at least one of a peripheral component interconnect express (PCIe) interface, a commute express link (CXL) interface, a die-to-die (D2D) interconnect interface, a chip-to-chip (C2C) interconnect interface, a graphics processing unit (GPU) interconnect interface, or a coherent accelerator processor interface (CAPI).

15. A system comprising:
a memory; and
a device, coupled to the memory and a computing system that hosts one or more guests, to perform operations comprising:
receiving a request to initiate a transaction involving a direct memory access (DMA) operation to access data associated with at least one of the one or more guests;
detecting a page fault associated with execution of the DMA operation of the transaction;
selecting, from a plurality of transaction fault handling protocols, a transaction fault handling protocol that is to be initiated to address the detected page fault; and
causing the selected transaction fault handling protocol to be performed to address the detected page fault.

16. The system of claim 15, wherein the transaction fault handling protocol is selected based on at least one of:
characteristics associated with the device;
characteristics associated with the one or more guests;
properties of the transaction requested to be initiated; or
properties of one or more prior transactions initiated at the device.

17. The system of claim 16, wherein at least one of the transaction or the one or more prior transactions correspond to one or more of:
a communication flow-type transaction;
a queue-type transaction; or
a sub-device type transaction.

18. The system of claim 15, wherein the device is an emulation-capable device that is configured to expose a plurality of emulated devices each having a distinct interface type to the computing system, and wherein the transaction fault handling protocol is selected from the plurality of transaction fault handling protocols based on an interface time of an emulated device corresponding to the transaction.

19. The system of claim 15, wherein the selected transaction fault handling protocol involves one or more of:
rescheduling at least one operation of the transaction, wherein the at least one operation comprises the DMA operation or another operation of the transaction;
terminating the at least one operation of the transaction; or
updating a memory address associated with at least one of the one or more DMA operations of the transaction to correspond to another memory address.

20. A non-transitory computer-readable medium storing instructions thereon, wherein the instructions, when executed by a processing device of a computing system that hosts one or more guests, cause the processing device to perform operations comprising:
receiving a request to initiate a transaction involving a direct memory access (DMA) operation to access data associated with at least one of the one or more guests;
detecting a page fault associated with execution of the DMA operation of the transaction;
selecting, from a plurality of transaction fault handling protocols, a transaction fault handling protocol that is to be initiated to address the detected page fault; and
causing the selected transaction fault handling protocol to be performed to address the detected page fault.
